(19) United States
(12) Patent Application Publication
(10) Pub. No.: US 2026/0306222 A1
(43) Pub. Date: Oct. 8, 2026

(54) DENTAL DEVICE AND DENTAL BRACKET

(71) Applicant: SOVE, Inc., Columbus, OH (US)

(72) Inventors: Wenchi WANG, Columbus, OH (US); Yung-Chieh Hsu, Denver, CO (US)

(73) Assignee: SOVE, Inc., Columbus, OH (US)

(21) Appl. No.: 19/716,086

(22) Filed: Jun. 22, 2026

Related U.S. Application Data
(63) Continuation-in-part of application No. 18/218,378, filed on Jul. 5, 2023.
(60) Provisional application No. 63/393,454, filed on Jul. 29, 2022.

(51) Int. Cl. A61C 7/14

(52) U.S. Cl. CPC A61C 7/146

(57) ABSTRACT

A dental device includes a dental bracket, and the dental bracket is securable to a respective tooth. The dental device includes a support member attached to the dental bracket via an extension, and the extension supports the respective dental bracket in a predetermined position. The dental device may further include a guide connected to the extension at a position between the dental bracket and the support member, and the guide may direct cutting of the dental bracket from the respective extension.

### CROSS REFERENCE TO RELATED APPLICATIONS

This application is a continuation-in-part of U.S. Application No. 18/218,378, filed on Jul 5th, 2023, which claims the benefit of U.S. Provisional Application No. 63/393,454, filed on Jul 29th, 2022. The contents of these applications are incorporated herein by reference.

### BACKGROUND OF THE INVENTION

### 1. FIELD OF THE INVENTION

This disclosure relates to a dental device, and in particular to a dental device that assists in applying one or more dental brackets to teeth.

### 2. DESCRIPTION OF THE PRIOR ART

Orthodontic treatment uses a device for aligning teeth into a desired arrangement. Generally, an orthodontic appliance includes brackets that are individually secured to respective teeth, as well as a wire that connects each of the dental brackets, such that the teeth are moved by a combined acting force of the dental brackets and the wire. In the current art, commonly used bonding manners include direct bonding and indirect bonding. Indirect bonding uses a model or a pre-made mold so that an entire set of the orthodontic appliance (including all dental brackets and additional components, such as expanders, skeletal temporary anchorage devices (TADs), a transpalatal arch (TPA), anterior-posterior correctors, and the like) is applied to the teeth at one time. However, indirect bonding requires fabricating a mold and the related components, resulting in higher cost and a longer fabrication time. In direct bonding, each dental bracket needs to be individually secured to a respective tooth; this manner is comparatively time-consuming, and it is difficult to ensure that the arrangement of the dental brackets conforms to the setting of the overall orthodontic appliance. For example, if the position of the first dental bracket is slightly deviated, the dentist performing the orthodontic treatment may be unable to immediately notice it, and may not discover the problem until all of the dental brackets have been installed. In order to correct the error, the dentist performing the orthodontic treatment may need to adjust the already-installed dental brackets one by one, and this adjustment process is not only difficult but also time-consuming.

Therefore, there is an urgent need in the art for a technique or a device that can quickly apply and secure dental brackets to teeth, such that a dentist performing the orthodontic treatment can install all of the dental brackets at the precise positions at one time during the application process. In addition, there is also an urgent need in the art for a technique that can simultaneously apply all of the dental brackets and a corresponding wire, so as to improve the installation efficiency of the orthodontic appliance and reduce the application time.

### SUMMARY OF THE INVENTION

This disclosure provides at least one embodiment of a dental device. The dental device includes a dental bracket, which is configured to be secured to a respective tooth. The dental device further includes a support member, which is connected to the dental bracket via an extension, and the extension supports the respective dental bracket in a predetermined position.

In at least one embodiment of the dental device, the extension may support the respective dental bracket in a predetermined position, such that the respective dental bracket can be aligned with the respective tooth. The dental device may further include a wire, the wire being pre-threaded through a connector of the dental bracket. The dental bracket may include a housing having a curved surface, the curved surface being alignable with a tooth, and including a cutout to increase a surface area of the curved surface. The dental bracket may include a connector integrated with the housing, the connector being connectable with the wire. The dental device may be fabricated from a single continuous mold, such that the support member, the dental bracket, and the extension are an integrally formed structure. The dental bracket may include a connector connected with the wire. The dental bracket may also include an aperture, the aperture extending from one surface of the dental bracket to another surface, such that the wire can pass through the aperture and be connected therewith. The support member may include a block, the block being configured to guide the dental device on the tooth. The support member may rest on a palate of a user, such that the dental bracket extends towards the tooth. The dental device may further include a guide, the guide being connected to the extension and disposed between the dental bracket and the support member, so as to guide cutting of the dental bracket from the respective extension. The guide may include a pair of appendages, the pair of appendages defining a pathway, the pathway being configured to guide cutting of the dental bracket from the respective extension. The dental device may further include a cutter, the cutter being engageable with the guide and being configured to cut the dental bracket from the extension.

This disclosure provides at least one embodiment of a dental bracket. The dental bracket includes a housing having a curved surface, the curved surface being configured to align with a tooth, and including a cutout to increase a surface area of the curved surface. The cutout can increase a surface area of the dental bracket that contacts an adhesive, so as to promote the bonding of the dental bracket with the tooth. The dental bracket further includes a connector, the connector being integrated with the housing and configured to connect with a wire.

In at least one embodiment of this disclosure, the connector includes an aperture, the aperture penetrating from one surface of the housing to another surface, so as to allow the wire to pass through the dental bracket. The connector may further include a stanchion, the stanchion being configured to secure the wire when a band is applied to the stanchion. The cutout can increase a surface area of the dental bracket that contacts an adhesive, so as to enhance the bonding force of the dental bracket with the tooth. The dental bracket can be separated from a support member of a dental device, so as to facilitate its application to a tooth. The connector may include a channel penetrating through the housing.

At least one embodiment of this disclosure further provides a method of applying a dental bracket and/or a dental device. The method includes: positioning a dental device in an oral cavity of a user, such that a dental bracket extends from a support member to a tooth of the user; activating an adhesive, so as to secure the dental bracket to the tooth of the user; and separating the dental bracket from the support member, such that the dental device can be removed from the oral cavity, while the dental bracket remains secured to the tooth.

In at least one embodiment of this disclosure, the method may further include: passing a wire through the dental bracket, so as to apply an orthodontic force to the tooth. The method may further include: adjusting a position of the dental bracket on the tooth while the dental bracket is still connected to the support member. The method may include cutting or drilling the extension, so as to separate the dental bracket from the support member. The support member and the dental bracket may be formed from a continuous material. Separating the dental bracket from the support member may include: applying a cutter at a pathway for the extension, so as to separate the dental bracket from the extension. The application of the dental device can apply all of the dental brackets at one time without requiring a mold or a model.

This disclosure provides at least one embodiment of a device and a method that, by using a support member and an extension, apply dental brackets to teeth in a simultaneous manner. A dentist can pre-align the dental brackets at a desired occlusal position through a digital design, and transfer the design to the teeth of the user, so as to accelerate the alignment process of the orthodontic appliance.

Some other embodiments that accelerate the process pre-thread a wire through the dental device, such that the dentist can place the dental bracket and the wire onto the teeth at one time, without needing to additionally secure the wire after bonding. After the dentist performing the orthodontic treatment pre-applies an adhesive to a base pad of the dental bracket and places the dental bracket on the teeth in a desired arrangement, the adhesive is activated, so as to lock the dental bracket in an appropriate position and to cut it from the extension. Through this design, the dentist performing the orthodontic treatment can simultaneously apply and align a plurality of dental brackets before the adhesive is activated, thereby shortening the application time of the orthodontic appliance and reducing the risk of an error affecting the arrangement of other dental brackets.

In addition, by causing all of the dental brackets to extend from the support member, the dentist performing the orthodontic treatment can directly align the dental brackets, without needing to take them out one by one from a tray or other storage device. After the installation is completed, a cutting tool (such as a drill or a cutter) can be guided through the guide to cut the dental bracket, so as to improve the cutting precision and reduce residual material on the dental bracket.

The dental bracket may be designed to include one or more cutouts. The cutout may correspond to a raised portion, such that a suspension mesh structure is formed inside the dental bracket. This design can enhance the bonding strength between the dental bracket and the respective tooth, because the adhesive can fill the cutout and surround the raised portion, so as to enhance the retention force between the adhesive and the respective tooth.

Advantageously, the overall dental device can be fabricated from a continuous material, and can be fabricated through a variety of techniques (such as 3D printing), thereby reducing production cost.

The orthodontic appliance as described in this disclosure includes the dental bracket and the wire, and the orthodontic appliance can apply an orthodontic force to the teeth, so as to rearrange the teeth into a desired position.

In some other embodiments of this disclosure, the support member may include a plurality of segments arranged along an arch shape, wherein adjacent segments among the plurality of segments are separated from each other, or are detachably connected to each other via a latch structure. Each of the segments can carry at least one respective dental bracket, and supports, via at least one respective extension, the at least one respective dental bracket in a predetermined position. By configuring the support member as a plurality of segments, the interference with other oral structures when the dental device is introduced into the oral cavity can be reduced, and segmented fabrication and local replacement are facilitated. In certain embodiments, the plurality of segments may include a left front section, a right front section, a left rear section, and a right rear section, respectively corresponding to respective regions of the oral cavity of the user. In other embodiments, the latch structure may include a tenon disposed at an end portion of one of the plurality of segments, and a mortise disposed at an end portion of another segment, among the plurality of segments, adjacent to the one segment, wherein a shape of the tenon corresponds to the mortise, such that the tenon can be inserted into the mortise, so as to detachably engage the adjacent segments with each other.

In still other embodiments of this disclosure, the dental device may include a plurality of dental brackets, each of the dental brackets may further include an insertion portion, and the support member may further include a plurality of receiving members, the plurality of receiving members respectively corresponding to the respective dental brackets. The insertion portion of each of the dental brackets is configured to engage with a respective receiving member among the plurality of receiving members, such that each of the dental brackets is supported in a predetermined position through the engagement of the respective receiving member with the insertion portion. The insertion portion may include a body and at least one support stem extending from the body, the at least one support stem being connected to each of the dental brackets. Through this configuration, each of the dental brackets can be pre-fabricated and selectively assembled, according to the needs of the user, to the respective receiving member of the support member, and a position of each of the dental brackets on the support member can be independently adjusted, so as to facilitate threading and aligning of the wire. After each of the dental brackets is secured to a tooth, each of the dental brackets can be separated from the support member by cutting the at least one support stem.

The features of the foregoing embodiments can be integrated with each other; for example, the configuration of the segmented support member can be implemented in combination with the configuration of the insertion-type dental bracket; or the configuration of the insertion-type dental bracket can be integrated into an integrally formed support member, all of which fall within the scope of this disclosure.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

This disclosure can be better understood through the following detailed description in conjunction with the accompanying drawings. It is to be emphasized that, in accordance with common practice, the various features in the drawings are not drawn to scale, but rather, for the sake of clarity, the dimensions of the various features are appropriately enlarged or reduced.

FIG. 1 is a perspective view of an example of a dental device secured to teeth.

FIG. 2 is a perspective view of another example of a dental device secured to teeth.

FIG. 3 is a perspective view of another example of a dental device secured to teeth.

FIG. 4A is a perspective view of a dental bracket that can be used with any one of the dental devices of FIGS. 1 to 3.

FIG. 4B is a cross-sectional view of the dental bracket of FIG. 4A, which can be used with any one of the dental devices of FIGS. 1 to 3.

FIG. 5 is a perspective view of another example of a dental device secured to teeth.

FIG. 6 is a perspective view of an orthodontic appliance on teeth.

FIG. 7 is a perspective view of a dental device on teeth.

FIG. 8 is a perspective view of a dental device on teeth.

FIG. 9A is a perspective view of a dental device.

FIG. 9B is a perspective view of the dental device of FIG. 9A, showing a dental bracket connected to a support member.

FIG. 9C is a cross-sectional view of the dental device of FIG. 9A used together with a drill.

FIG. 10A is a perspective view of a guide in a position for drilling.

FIG. 10B is a back view of another embodiment of a dental bracket similar to FIG. 4A, showing a recess filled with a weakened portion further formed in the dental bracket.

FIG. 10C is a bottom view of the dental bracket of FIG. 10B.

FIG. 10D is a top view of the dental bracket of FIG. 10B.

FIG. 10E is a schematic structural view of the dental bracket of FIG. 10B integrally formed with an extension, wherein the dental bracket and the extension are maintained connected to each other through the weakened portion.

FIG. 10F is a schematic structural view of the dental bracket of FIG. 10B after the extension is separated therefrom, wherein the weakened portion remains in the recess.

FIG. 11 is a schematic top view of a clear aligner secured to upper teeth.

FIG. 12 is a perspective view of another example of a dental device, showing a support member having a plurality of segments.

FIG. 13A is a perspective view of another example of a dental device, showing a dental bracket engaged with a receiving member of a support member via an insertion portion.

FIG. 13B is a partial enlarged view of the dental device of FIG. 13A, showing a state in which the insertion portion of the dental bracket is separated from the receiving member of the support member.

FIG. 13C is a partial enlarged view of the dental device of FIG. 13A, showing a state in which the insertion portion of the dental bracket is engaged with the receiving member of the support member.

### DETAILED DESCRIPTION

The following description of embodiments illustrates the embodiments of this disclosure. A person having ordinary skill in the art to which this disclosure pertains can readily understand the advantages and effects of this disclosure based on the content disclosed herein. However, the embodiments described herein are not intended to limit the scope of this disclosure, and this disclosure may also be implemented or applied by other different embodiments; the various details described herein may also be given various changes or modifications based on different viewpoints and applications, without departing from the spirit of this disclosure.

The proportions, structures, sizes, and other features shown in the drawings appended herein are used only to accompany the content disclosed herein, for reading and understanding by a person having ordinary skill in the art to which this disclosure pertains, and are not intended to limit the implementable scope of this disclosure; therefore, any change in proportional relationship, modification of structure, or adjustment of size shall, without affecting the objectives that this disclosure can achieve and the effects that it can produce, fall within the scope that the technical content disclosed herein can encompass.

Where the terms "include," "comprise," or "have" particular elements are described herein, unless otherwise stated, other elements, structures, regions, portions, devices, systems, or connection relationships, and the like, may further be included, rather than excluding such other elements.

Unless expressly stated otherwise herein, the singular forms "a," "an," and "the" described herein also include the plural forms, and "or" described herein is used interchangeably with "and/or."

This disclosure relates to a dental device, which includes a support member, the support member being configured to guide the placement of dental brackets, such that a dentist can simultaneously install all of the dental brackets at predetermined positions on the teeth. Since the dental brackets are connected to the support member via extensions that can be cut from the dental brackets, the dentist can, before securing the dental brackets, adjust the arrangement of the dental brackets according to the needs of an individual patient. After all of the dental brackets have been positioned in appropriate positions, they can be secured at one time, without needing to install each of the dental brackets one by one, thereby avoiding the problem of having to readjust individual dental brackets when the wire fails to align correctly. In addition, each dental bracket may include one or more cutouts and/or raised portions, such that a dentist performing the orthodontic treatment can apply an appropriate amount of adhesive, and retain the adhesive inside the dental bracket through the cutouts, so as to enhance the adhesion of the dental bracket to the tooth. Further providing a guide can assist the dentist performing the orthodontic treatment in quickly applying the dental bracket and separating the dental bracket from the extension, so as to reduce or eliminate material remaining on the dental bracket after cutting or drilling.

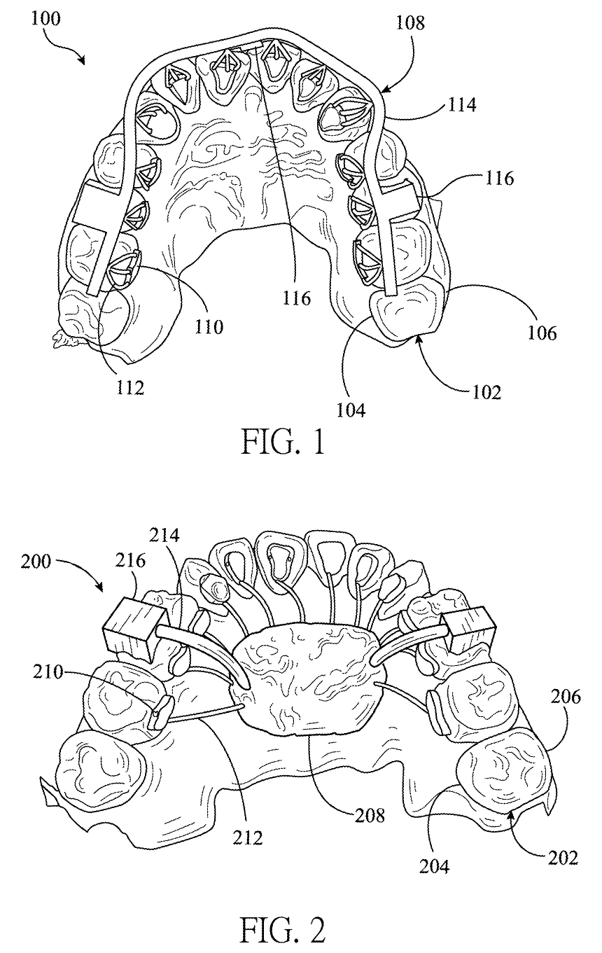

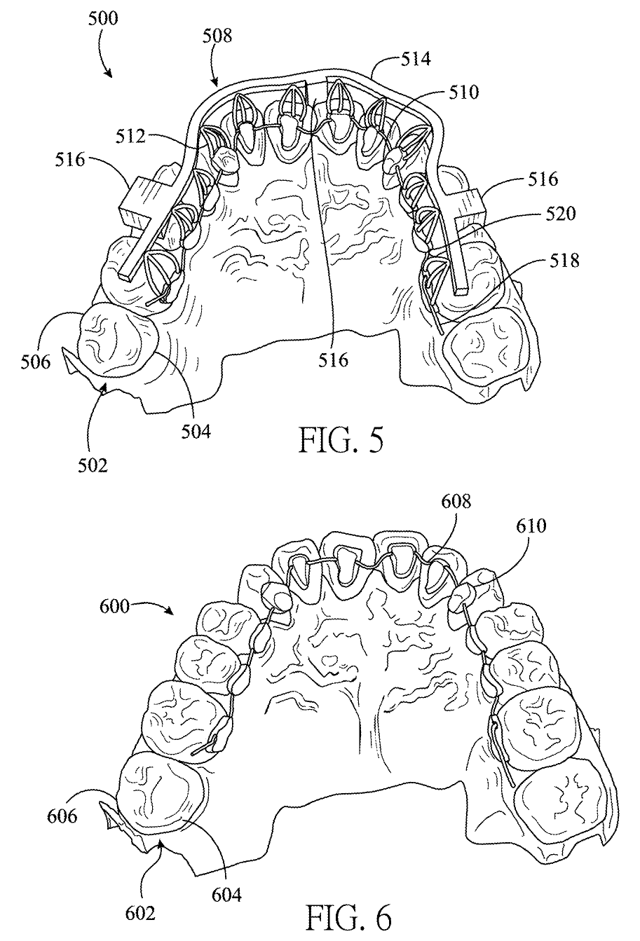

FIG. 1 is a perspective view of an example of a dental device 100 secured to teeth 102. The dental device 100 is installed on a lingual side 104 of the teeth 102, such that when a part of the dental device 100 is removed from the oral cavity, an orthodontic appliance (not shown) can be hidden by a buccal side 106 of the teeth 102 and is not easily noticed by others. The dental device 100 includes a support member 108 and a dental bracket 110, and the dental bracket 110 is connected to the support member 108 via an extension 112. The extension 112 may be a malleable material, such that the dental bracket 110 can be adjusted along the lingual side 104 of the teeth 102 to a desired arrangement or position, and then a wire (such as the wire 518 in FIG. 5) is arranged. The dental bracket 110 is configured to accommodate and/or connect with a wire (such as the wire 518 in FIG. 5), so as to apply an orthodontic force to the teeth 102, thereby moving the teeth to an ideal arrangement position.

The support member 108 includes a beam 114 and a block 116, which are configured to guide the dental device 100 to be secured to the teeth 102. The beam 114 may have any suitable configuration for supporting the block 116 and the dental bracket 110, such that the dentist can efficiently secure the orthodontic appliance within the oral cavity of the user. In some embodiments, the support member 108 does not include the block 116, and the beam 114 may directly contact the teeth 102. In this scenario, the beam 114 may have a shape corresponding to the shape of the teeth 102, so as to ensure alignment and securing. In addition, in other embodiments, the beam 114 may be a malleable material, such that the dentist can press the beam 114 against the teeth 102 and adjust its bending to align with the top surface of the teeth 102. For example, an auxiliary element (not shown) may be included, so as to assist in applying the adhesive onto the dental bracket 110 and/or the teeth 102, such that the dentist can quickly apply the adhesive.

The block 116 is illustrated as being square; however, it may have other shapes, so as to provide a sufficient support base, thereby reducing or mitigating the wobbling that the dental device 100 may produce when securing the dental bracket 110. For example, the block 116 may be rectangular, cylindrical, circular, or any combination thereof. The surface of the block 116 that contacts the teeth 102 may be configured to align with a side surface or a top surface of the teeth 102. In other embodiments, the block 116 is malleable, such that when the dental device 100 is placed on the teeth 102, it can more closely conform to the tooth shapes of different users. In addition, the block 116 may have a suitable shape, such that it can appropriately fit into the grooves between the teeth 102. The support member 108 may include a sufficient number of blocks 116, so as to ensure the alignment accuracy of the dental bracket 110 on the teeth 102. For example, the support member 108 may include one or more, two or more, three or more, four or more, five or more, or a plurality of blocks 116.

The support member 108 may include a suitable amount or a particular type of dental bracket 110, so as to accommodate different orthodontic devices or orthodontic appliances. For example, the support member 108 may include a number of dental brackets 110 corresponding to the teeth 102, so as to satisfy the needs of a particular user. In addition, the support member 108 may also include a smaller number of dental brackets 110, rather than being consistent with the number of teeth 102. For example, certain orthodontic elements may be inserted as expanders, and they are not applied to all of the teeth 102 in the oral cavity. In other embodiments, the dental bracket 110 may not be used, and another orthodontic element may be used instead. The support member 108 may include any one or more orthodontic elements, which are connected to the support member 108 via the extension 112. The extension 112, as illustrated, extends from the lingual side 104 of the beam 114, such that the dental bracket 110 can be secured to the lingual side 104 of the teeth 102. In other configurations, an additional extension 112 may be added on the buccal side 106 of the beam 114, and an additional dental bracket 110 or an alternative orthodontic element may be included. Similarly, when the dental bracket 110 is secured to the buccal side 106 of the teeth 102, an extension 112 including an alternative orthodontic element or dental bracket 110 may be arranged on the lingual side 104 of the beam 114.

The function of the extension 112 lies in providing a malleable and separable connection between the dental bracket 110 and the support member 108. The extension 112 can be both malleable, so as to allow the dentist to adjust the position of the dental bracket 110, and maintain a certain rigidity, such that the dental bracket 110 remains in the desired position after adjustment, unless the dentist performs adjustment again. The extension 112 can be separated from the dental bracket 110 by cutting or drilling, so as to separate the support member 108 from the dental bracket 110 and remove it from the oral cavity. The cutting or drilling can be accomplished by any tool sufficient to separate two elements. In addition, in other embodiments, the extension 112 may be caused to be separated from the dental bracket 110 and/or the support member 108 by means of solvent treatment, heating, or ultraviolet light irradiation, and the like. The extension 112 may include one or more weakened regions adjacent to the support member 108 and/or the dental bracket 110, such that it is more easily cut or separated than other regions.

FIG. 2 shows a dental device 200 of another embodiment, the dental device 200 being secured to teeth 202. The dental device 200 is arranged on a lingual side 204 of the teeth 202, such that when the orthodontic appliance is secured, the orthodontic appliance cannot be directly seen from a buccal side 206 of the teeth 202. The dental device 200 includes a support member 208, which is connected to a dental bracket 210 via an extension 212. The structures of the support member 208, the dental bracket 210, and the extension 212 may be similar to those of the support member 108, the dental bracket 110, and the extension 112 shown in FIG. 1.

The support member 208 includes an extension 214, the extension 214 being further connected to a block 216, so as to prevent the dental device 200 from sliding or becoming misaligned when worn. In addition, the block 216 may be configured according to the oral structure of the user, so as to assist the dental bracket 210 in precise alignment. Like the block 116 shown in FIG. 1, the block 216 may have a shape suitable for guiding the dental device 200 on the teeth 202. The support member 208 may be a malleable material, such that the dentist can adjust its shape so as to more closely conform to the oral structure of the user, thereby improving the alignment accuracy of the dental device 200.

The support member 208 may be designed in any suitable shape, so as to avoid affecting the dentist's operation of installing the dental bracket 210 on the teeth 202. In addition, the support member 208 may be disposed on an upper palatal surface within the oral cavity or on gum tissue, so as to provide auxiliary support. The support member 208 may also be designed to be suitable for being placed at the bottom of the oral cavity (i.e., beneath the tongue), so as to reduce interference with the dentist when installing the dental bracket 210.

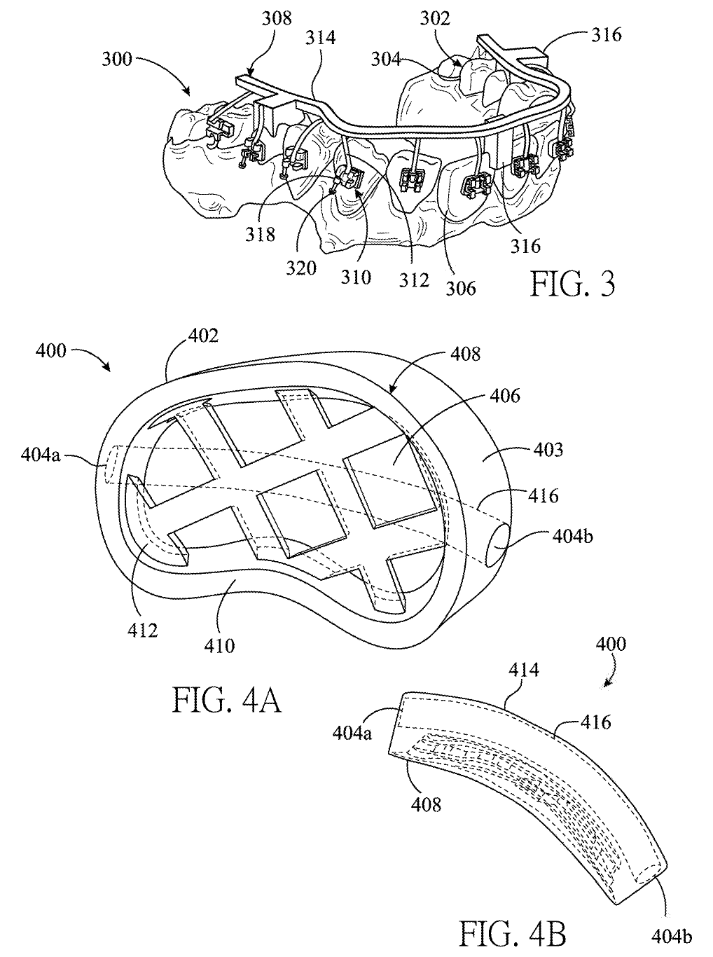

FIG. 3 shows a dental device 300 of another embodiment, the dental device 300 being secured to teeth 302. The dental device 300 is arranged on a buccal side 306 of the teeth 302; compared with a lingual side 304, its installation is more convenient. The dental device 300 includes a support member 308, which is connected to a dental bracket 310 via an extension 312. The support member 308 further includes a beam 314, the beam 314 being disposed on a block 316, such that the beam 314 is spaced apart from the teeth 302 so as to avoid direct contact. The structures of the support member 308, the dental bracket 310, the extension 312, the beam 314, and the block 316 may be similar to those of the support members 108 and 208, the dental brackets 110 and 210, the extensions 112 and 212, the beam 114, and the blocks 116 and 216 shown in FIGS. 1 to 2.

The dental bracket 310 includes stanchions (tie wings) 318, such that a wire (for example, the wire 518 of FIG. 5) can be arranged in a slot within the stanchions 318 and be secured via upper and lower stanchions 318. In addition, a band (not shown) may be used to further secure the wire (for example, the wire 518 of FIG. 5) to the dental bracket 310. The dental bracket 310 may include any number of stanchions 318, so as to ensure that the wire (for example, the wire 518 of FIG. 5) is secured to the dental bracket 310. For example, the dental bracket 310 may include 2 to 8 stanchions 318.

The dental bracket 310 includes a connector 320, the connector 320 being usable for connecting a band (not shown), so as to assist in adjusting the position of a lower jaw. According to the needs of the user or the dentist, the dental bracket 310 may include one or more connectors 320, and a single dental bracket 310 may include a plurality of connectors 320. In certain embodiments, the connector 320 may be replaced by another orthodontic component, and the orthodontic component may be used to adjust the arrangement of the teeth 302 of the user.

FIG. 4A shows a backside view of a dental bracket 400, the dental bracket 400 being applicable to the dental devices 100, 200, 300 shown in FIGS. 1 to 3. The dental bracket 400 includes an outer periphery 402 (or an outer surface), the outer periphery 402 being connected with a side surface 403, and the side surface 403 having apertures 404a and 404b, the apertures 404a and 404b forming a channel 416, the channel 416 being usable for accommodating a wire (for example, the wire 518 of FIG. 5). The apertures 404a and 404b may have any size or configuration, so as to accommodate the wire (for example, the wire 518 of FIG. 5), and the wire 518 can apply an orthodontic force to the dental bracket 400 and/or a tooth (not shown), so as to adjust or align a tooth (not shown) to a desired position. In certain embodiments, the dental bracket 400 may further include another set of apertures (not shown), and the apertures may form another channel (not shown) so as to accommodate a second wire, which can be used to assist in adjusting the position of a tooth (not shown). In addition, the dental bracket 400 may include additional apertures (not shown) and/or channels (not shown) arranged in other orientations, so as to connect with other orthodontic components for rearranging or adjusting teeth.

In order to improve the bonding effect of the dental bracket 400 with a tooth, a cutout 406 is provided on a back side 408 of the dental bracket 400. The cutout 406 can improve the retention force (bonding force) of the dental bracket 400, such that the dentist can apply an adhesive before the dental device (for example, the dental device 100, 200, 300) is inserted into the oral cavity, so as to reduce or prevent the adhesive from dripping when the dental bracket 400 is applied to a tooth. The back side 408 is the portion of the dental bracket 400 that contacts a tooth (not shown) when the dental device (for example, the dental devices 100, 200, 300 shown in FIGS. 1 to 3) is used to secure the orthodontic appliance. The dental bracket 400 may include any number of cutouts 406, so as to ensure that when the dental bracket 400 is secured to a tooth (not shown), the bonding effect can be improved, and the surface area can be increased, so as to prevent the adhesive from dripping off the dental bracket 400 before activation. For example, the dental bracket 400 may include 1 to 30 cutouts 406.

On the back side 408, a ledge 410 adjacent to the outer periphery 402 is provided, and the cutout 406 is separated by a raised surface 412. The cutouts 406 may form a continuous region for deposition of an adhesive, and the raised surface 412 is located above the continuous region, such that it functions as a mesh structure (for example, a suspension mesh configuration). The combined action of the ledge 410 and the cutout 406 can improve the retention capability of the adhesive on the dental bracket 400, whether the adhesive is applied before or after the dental device (for example, the dental devices 100, 200, 300 shown in FIGS. 1 to 3) is inserted into the oral cavity. Since the cutout 406 forms a recessed surface relative to the outer periphery 402 and/or the ledge 410, the adhesive pre-applied to the dental bracket 400 does not drip off the dental bracket 400 before activation, thereby accelerating the process of securing the orthodontic appliance within the oral cavity of the user. The surfaces of the ledge 410 and the raised surface 412 may be relatively uniform and flat. In certain embodiments, the ledge 410 and the raised surface 412 form a continuous flat surface. In other embodiments, the surfaces of the ledge 410 and the raised surface 412 may be stepped. For example, when the ledge 410 is higher than the raised surface 412, and the raised surface 412 is higher than the cutout 406, the cutout 406 and the raised surface 412 may additionally be filled with an adhesive, and the adhesive can be confined by the ledge 410 between the dental bracket 400 and a tooth (not shown), so as to enhance the adhesion of the dental bracket 400 with a tooth (not shown), and to prevent the adhesive from leaking beyond the ledge 410. In certain embodiments, the dental bracket 400 may not include a complete raised surface 412, but rather have more open cutouts 406, thereby maximizing the volume within the dental bracket 400 that can be filled with adhesive, and thus enhancing the adhesion capability.

FIG. 4B is a cross-sectional view of the dental bracket 400 shown in FIG. 4A, the dental bracket 400 being applicable to the dental devices 100, 200, 300 shown in FIGS. 1 to 3. The dental bracket 400 includes a front side 414 and a back side 408, with a channel 416 sandwiched therebetween. The channel 416 extends through the apertures 404a, 404b, such that a wire (for example, the wire 518 of FIG. 5) can pass through the channel 416, so as to secure the orthodontic appliance to a tooth (not shown). The channel 416 is disposed behind the cutout 406, so as to maximize the internal volume of the cutout 406. In other embodiments, the channel 416 may extend through the cutout 406; this configuration can be adopted when the thickness of the front side 414 is insufficient to completely accommodate the channel 416. The cross-sectional shape of the channel 416 may be any shape suitable for allowing a wire (for example, the wire 518 of FIG. 5) to pass through. The cross-sectional area of the apertures 404a, 404b may be larger than the cross-sectional area of the channel 416, such that the dentist can more easily pass a wire (for example, the wire 518 of FIG. 5) through the apertures 404a, 404b and the channel 416, because the openings of the apertures 404a, 404b are larger. For example, the channel 416 may have a circular, rectangular, triangular, or any shape suitable for threading a wire (for example, the wire 518 of FIG. 5). In certain embodiments, the channel 416 may be designed as a tapered structure, such that it is narrowest at a central portion of the dental bracket 400, and widest adjacent to or at the apertures 404a, 404b, so as to improve the convenience of threading the wire. The dental bracket 400 may include one or more channels 416, so as to allow one or more wires (for example, the wire 518 of FIG. 5) to be arranged. The front side 414 and the back side 408 may have a curved surface, such that the dental bracket 400 can conform to a particular tooth (not shown). The front side 414 and the back side 408 may have any configuration suitable for conforming to the shape of a tooth (not shown). In other embodiments, the front side 414 and the back side 408 may not have a curved surface, but rather be of a generally straight-line configuration, so as to accommodate different orthodontic needs.

The combination of the channel 416 and the apertures 404a, 404b may be described as a connector for connecting with a wire (for example, the wire 518 of FIG. 5). The connector may be used to connect a dental bracket (for example, the dental brackets 110, 210, 310, 400 of FIGS. 1 to 4B) with a wire (for example, the wire 518 of FIG. 5), so as to adjust and/or rearrange the teeth of the user. The connector may be used in conjunction with one or more other orthodontic elements described herein, these orthodontic elements being used to adjust and/or rearrange teeth. The connector may penetrate through a dental bracket (for example, the dental brackets 110, 210, 310, 400 of FIGS. 1 to 4B), or may be disposed on an external surface of a dental bracket (for example, the dental brackets 110, 210, 310, 400 of FIGS. 1 to 4B), for example, disposed on the front side 414. For example, as described herein, the connector may be used in conjunction with a stanchion (for example, the stanchion 318 of FIG. 3), the stanchion being used to provide a passage, such that a wire (for example, the wire 518 of FIG. 5) can pass through, and be secured to a dental bracket (for example, the dental brackets 110, 210, 310, 400 of FIGS. 1 to 4B) via one or more bands.

FIG. 5 is a perspective view of another example of a dental device 500, the dental device 500 being secured to teeth 502. The dental device 500 is connected to a lingual side 504 of the teeth 502, such that when the orthodontic appliance is assembled, the orthodontic appliance cannot be seen from a buccal side 506 of the oral cavity. The dental device 500 includes a support member 508, the support member being connected to a dental bracket 510 via an extension 512. The support member 508 includes a beam 514 and a block 516, the block 516 being used to assist the dental device 500 in aligning with the teeth 502. The structures of the support member 508, the dental bracket 510, the extension 512, the beam 514, and the block 516 may be similar to the support members 108, 208, and 308, the dental brackets 110, 210, 310, and 400, the extensions 112, 212, and 312, the beams 114 and 314, and/or the blocks 116, 216, and 316 shown in FIGS. 1 to 4B. The dental device 500 further includes a wire 518, the wire 518 being pre-threaded through a connector 520 of the dental bracket 510, so as to accelerate the process of applying the orthodontic appliance to the teeth 502. The connector 520 may be similar to the channel 416 and the apertures 404a, 404b of FIGS. 4A to 4B, or similar to the stanchion 318 of FIG. 3. An adhesive may be applied to the dental bracket 510 before or after the dental device 500 is installed on the teeth 502.

The wire 518 may be used to apply an orthodontic force to the dental bracket 510 and/or the teeth 502, so as to adjust the position and/or arrangement of the teeth 502 of the user. The wire 518 may have any configuration suitable for adjusting the position and/or arrangement of the teeth 502 of the user, and may be made of any material sufficient to adjust the position and/or arrangement of the teeth 502 of the user, for example, a metal, a plastic, or a combination thereof. In the example shown in FIG. 5, the wire 518 is pre-loaded, pre-threaded, or pre-installed into the dental bracket 510 before the dental device 500 is installed within the oral cavity of the user. In other examples, the wire 518 is added only after the dental bracket 510 is secured to the teeth 502 via an adhesive. The wire 518 may be pre-formed or pre-aligned, so as to connect a plurality of dental brackets 510 and apply an orthodontic force thereto, such that the dental brackets 510 are pre-aligned to an arrangement suitable for the teeth 502 of a particular user.

Although not shown, the dental devices 100, 200, 300, 500 of FIGS. 1 to 3 and 5 may include any other orthodontic element included in a conventional orthodontic device. For example, the dental devices 100, 200, 300, 500 may include orthodontic elements, such as a loop, a hook, a buccal tube, a button, a transpalatal arch, a lower lingual holding arch, a rapid palatal expander, a lingual bonded retainer, a Nance appliance, a W arch, palatal temporary anchorage devices (TADs), a MARA corrector, a Carriere corrector, a Herbst corrector, or any other element sufficient to adjust or rearrange the teeth of the user. In certain embodiments, a dental bracket (for example, the dental brackets 110, 210, 310, 400, 510 of FIGS. 1 to 5) may be used in conjunction with, or replaced by, one or more orthodontic elements. The dental devices 100, 200, 300, 500 may be disposed within the oral cavity or on the teeth as described herein, while other orthodontic elements are installed or secured within the oral cavity or on the teeth.

In certain embodiments, it may be necessary to apply two dental devices (not shown), and to install them in sequence. For example, a first dental device (not shown) may be applied to the lower teeth first; after the lower dental brackets of the first dental device are secured to the teeth and separated from the extensions, a second dental device (not shown) is then applied to the upper teeth, and the second dental device may subsequently be removed from the upper teeth. The upper and lower dental devices (not shown) may have the same configuration (for example, a dental device including all of the dental brackets), or the upper and lower dental devices (not shown) may include different types of dental brackets, orthodontic elements, or both.

In certain embodiments, the dental devices 100, 200, 300, 500 may be pre-customized and designed according to the oral cavity of a particular user, such that a dental bracket (for example, the dental brackets 110, 210, 310, 400, 510 of FIGS. 1 to 5) can be pre-positioned, and may or may not include a wire (for example, the wire 518 of FIG. 5), so as to facilitate the dentist in quickly applying the orthodontic appliance. For example, before fabricating the dental devices 100, 200, 300, 500, a three-dimensional (3D) model or dental mold of the user's teeth may be established first, and the 3D model or dental mold may be used to determine the customized positioning of each element within the dental devices 100, 200, 300, 500, so as to achieve an optimal tooth arrangement and/or adjustment effect.

The dental devices 100, 200, 300, 500 described herein may be made of any material suitable for forming an orthodontic element. For example, the dental devices 100, 200, 300, 500 may be made of a metal material, a ceramic material, and/or a polymer material. In certain embodiments, the dental devices 100, 200, 300, 500 may be made of a mixture of a variety of materials, for example, a reinforced plastic, a copolymer, a metal alloy, or a hybrid ceramic material. Examples of the metal material include 316 stainless steel, cobalt-chromium alloy (CoCr), and titanium metal. Examples of the polymer material include polyurethane, polyethylene, poly(lactic-co-glycolic acid), polymethylmethacrylate, and/or polyether ether ketone. Examples of the ceramic material include aluminum oxide (Al2O3), zirconium oxide (ZrO2), porcelain, and/or hydroxyapatite. In certain embodiments, the support member (for example, the support members 108, 208, 308 of FIGS. 1 to 3) may be made of a first material, the dental bracket (for example, the dental brackets 110, 210, 310, 400, 510 of FIGS. 1 to 5) may be made of a second material, the second material being suitable for use as an orthodontic element, and the extension (for example, the extensions 112, 212, 312, 512 of FIGS. 1 to 3 and 5) may be made of a third material or a mixture of the first material and the second material.

The dental devices 100, 200, 300, 500 described herein may be fabricated through any technique suitable for fabricating an orthodontic device. The dental devices 100, 200, 300, 500 may be made of a single continuous material, and may be fabricated through any suitable process. For example, the dental devices 100, 200, 300, 500 may be fabricated through a 3D printing process, such that they become a single continuous material. In certain embodiments, the dental devices 100, 200, 300, 500 may be fabricated by direct printing or indirect printing. Examples of a suitable 3D printing process include lost wax casting, vat photopolymerization, material jetting, binder jetting, powder bed fusion, material extrusion, directed energy deposition, sheet lamination, direct metal laser sintering, or any combination thereof. In other embodiments, the dental device may be fabricated by injection molding, assembly, or any combination thereof.

The dental devices 100, 200, 300, 500 may be composed of a plurality of components, and these components may be connected to each other by bonding or other manners. For example, a support member (for example, the support members 108, 208, 308, 508 shown in FIGS. 1 to 3 and 5) may be bonded or connected to an extension (for example, the extensions 112, 212, 312, 512 shown in FIGS. 1 to 3 and 5), while a dental bracket (for example, the dental brackets 110, 210, 310, 400, 510 shown in FIGS. 1 to 5) may be bonded or connected to an extension (for example, the extensions 112, 212, 312, 512 shown in FIGS. 1 to 3 and 5). For example, a dental bracket (for example, the dental brackets 110, 210, 310, 400, 510) may be made of metal, while a support member (for example, the support members 108, 208, 308, 508) may be made of a plastic material, so as to reduce cost, while ensuring that the dental bracket (for example, the dental brackets 110, 210, 310, 400, 510) is made of an appropriate metal material, because the dental bracket (for example, the dental brackets 110, 210, 310, 400, 510) needs to remain secured to the teeth during the rearrangement and/or adjustment of the teeth. When different components (for example, the dental brackets 110, 210, 310, 400, 510 and the support members 108, 208, 308, 508) are made of different materials, the two components may be bonded or fused together by any manner sufficient to form a separable (for example, cuttable) connection.

The dental devices 100, 200, 300, 500 described herein may be applied to teeth by any method suitable for securing a dental bracket (for example, the dental brackets 110, 210, 310, 400, 510 shown in FIGS. 1 to 5) to a tooth, and removing a support member (for example, the support members 108, 208, 308, 508 shown in FIGS. 1 to 3 and 5) and/or an extension (for example, the extensions 112, 212, 312, 512 shown in FIGS. 1 to 3 and 5). For example, a support member (for example, the support members 108, 208, 308, 508) of the dental devices 100, 200, 300, 500 may be disposed on the teeth, such that a dental bracket (for example, the dental brackets 110, 210, 310, 400, 510) faces or covers the teeth, and an adhesive is applied onto the dental bracket (for example, the dental brackets 110, 210, 310, 400, 510). After the dental bracket (for example, the dental brackets 110, 210, 310, 400, 510) is coated with an adhesive, it can be positioned on the teeth, and the adhesive can be activated by any suitable method, such that the dental bracket (for example, the dental brackets 110, 210, 310, 400, 510) is secured to the teeth. Before the adhesive is activated, the position of the dental bracket (for example, the dental brackets 110, 210, 310, 400, 510) on the teeth can be adjusted. The dental bracket (for example, the dental brackets 110, 210, 310, 400, 510) may be cut and removed from the support member (for example, the support members 108, 208, 308, 508) before or after the adhesive is activated. The adhesive may be activated by heat, ultraviolet radiation, air, water, and/or pressure.

A wire (for example, the wire 518 shown in FIG. 5) may be connected with a dental bracket (for example, the dental brackets 110, 210, 310, 400, 510 shown in FIGS. 1 to 5) before or after the adhesive is activated. A wire (for example, the wire 518 shown in FIG. 5) and/or a dental bracket (for example, the dental brackets 110, 210, 310, 400, 510) may be adjusted before the adhesive is activated and/or before the dental bracket (for example, the dental brackets 110, 210, 310, 400, 510) is cut from the support member (for example, the support members 108, 208, 308, 508 shown in FIGS. 1 to 3 and 5), such that the dentist can quickly and simultaneously check the position of the dental bracket (for example, the dental brackets 110, 210, 310, 400, 510), and perform fine adjustments before the orthodontic appliance is formally secured within the oral cavity of the user. A support member (for example, the support members 108, 208, 308, 508) may be disposed or supported on the teeth and/or an upper palate, such that a dental bracket (for example, the dental brackets 110, 210, 310, 400, 510) extends towards the teeth. The dental devices 100, 200, 300, 500 may be installed on the upper or lower teeth first, and a dental bracket (for example, the dental brackets 110, 210, 310, 400, 510) may be secured to the upper or lower teeth in any order.

When the dental devices 100, 200, 300, 500 further include other orthodontic components, the orthodontic components may be installed onto the teeth in any order. A block (for example, the blocks 116, 216, 316, 516 shown in FIGS. 1 to 5) may be used to interlock with an occlusal surface of the teeth, such that a support member (for example, the support members 108, 208, 308, 508) remains stable when the dentist secures a dental bracket (for example, the dental brackets 110, 210, 310, 400, 510) to the teeth, so as to avoid movement or displacement. After a dental bracket (for example, the dental brackets 110, 210, 310, 400, 510) is secured to the teeth, an extension (for example, the extensions 112, 212, 312, 512 shown in FIGS. 1 to 3 and 5) may be cut, and a temporary adhesive on a support member (for example, the support members 108, 208, 308, 508) may be deactivated by breaking, heating, and/or ultraviolet light irradiation, so as to remove the support member from the oral cavity.

FIG. 6 is a perspective view of an orthodontic appliance 600 installed on teeth 602, the orthodontic appliance 600 being formed, after an extension (for example, the extensions 112, 212, 312, 512 shown in FIGS. 1 to 3 and 5) and a support member (for example, the support members 108, 208, 308, 508 shown in FIGS. 1 to 3 and 5) are cut, leaving only a dental bracket 610 and a wire 608, so as to form the orthodontic appliance 600. The orthodontic appliance 600 is arranged on a lingual side 604 of the teeth 602, such that the orthodontic appliance 600 is not visible from a buccal side 606 of the teeth 602. The orthodontic appliance 600 is secured to the teeth 602 via an adhesive, such that the dental bracket 610 firmly conforms to the teeth 602. The orthodontic appliance 600 may be applied or positioned on the teeth by any technique or method described herein. The dental bracket 610 and the wire 608 may be identical to the dental brackets 110, 210, 310, 400, 510 and the wire 518 shown in FIGS. 1 to 5. In other embodiments, the orthodontic appliance 600 may be arranged on the buccal side 606 of the teeth 602. Any one of the dental devices 100, 200, 300, 500 shown in FIGS. 1 to 3 and 5 can secure the orthodontic appliance 600 to the lingual side 604 or the buccal side 606 of the teeth 602.

After the teeth have reached a certain degree of preliminary arrangement, the wire 518, 608 can be removed, and clear aligner treatment can begin. In this stage, the wire 518, 608 can be replaced by a clear aligner 1102, as shown in FIG. 11. Conventionally, the clear aligner 1102 makes contact with raised structures adhered to the buccal-side surfaces of the teeth, so as to apply an orthodontic force. However, in the dental device 1100 shown in FIG. 11, a lingual dental bracket 1110 can replace these raised structures. Specifically, a plurality of dental brackets 1110 on a lingual side 1104 are arranged on teeth 1103 of an oral structure P of a patient, the dental brackets 1110 being disposed on the lingual side 1104 surface of each tooth 1103, and embedded in the clear aligner 1102, so as to produce an acting force with the clear aligner 1102, thereby driving the teeth to move to a finally desired arrangement position, and thus further achieving detailed adjustment of the teeth 1103. In at least one specific embodiment of this disclosure, the wire 518, 608 may be a nickel-titanium archwire, and the clear aligner 1102 may be an invisible aligner, but this disclosure is not limited thereto.

In at least one specific embodiment of this disclosure, a hybrid orthodontic method is used, the method may include a two-stage processing procedure, so as to achieve a desired tooth arrangement. The first stage uses a set of orthodontic dental bracket systems suitable for lingual installation (for example, but not limited thereto, the dental device 500 shown in FIG. 5 or the orthodontic appliance 600 shown in FIG. 6), in conjunction with a lingual wire (for example, but not limited thereto, the wire 518 shown in FIG. 5 or the wire 608 shown in FIG. 6), so as to perform a preliminary arrangement of the teeth. The second stage evaluates and adjusts the arrangement progress of the teeth, and removes the wire, and uses an orthodontic dental bracket (for example, but not limited thereto, the dental bracket 510 shown in FIG. 5, the dental bracket 610 shown in FIG. 6, or the dental bracket 1110 shown in FIG. 11) in combination with a clear aligner (for example, but not limited thereto, the clear aligner 1102 shown in FIG. 11), so as to complete a further arrangement of the teeth. The foregoing treatment procedure may be applied to the upper jaw or the lower jaw, or applied to both the upper and lower jaws simultaneously. One specific embodiment of the foregoing two-stage hybrid orthodontic method combining lingual orthodontics and clear-aligner orthodontics is described in detail below:

The first stage: First, an intraoral scan of the patient's dentition is performed, and each tooth in a 3D initial stage model is segmented; subsequently, CAD software is used to set the teeth of the initial stage model (ISM) to an ideal occlusal position. Then, an Initial Alignment Stage (IAS) is simulated, and computer-aided design (CAD) software is used to set the teeth of the IAS stage to an ideal occlusion, and a plurality of incremental models are then established based on the simulation, so as to simulate the movement from the IAS to the ideal occlusion. In the IAS stage, CAD software is used to design a customized lingual attachment having lingual tubes, and this lingual attachment is fabricated, and is then attached to the patient's teeth. Thereafter, a wire (for example, but not limited thereto, the wire 518 shown in FIG. 5 or the wire 608 shown in FIG. 6) is inserted into the lingual attachment (for example, but not limited thereto, the dental bracket 510 shown in FIG. 5 or the dental bracket 610 shown in FIG. 6), so as to align the teeth and achieve a preliminary leveling effect.

The second stage: After the preliminary alignment is completed, an intraoral scan is performed again to produce an Aligned Crude Model (ACM), and each tooth in this 3D ACM model is segmented. CAD software is used to reset the teeth of the ACM to an ideal occlusion, and an incremental model is established so as to simulate the movement from the ACM to the ideal occlusion. Subsequently, a clear aligner (for example, but not limited thereto, the clear aligner 1102 shown in FIG. 11) that can be used in conjunction with a lingual attachment (for example, but not limited thereto, the dental bracket 510 shown in FIG. 5, the dental bracket 610 shown in FIG. 6, or the dental bracket 1110 shown in FIG. 11) is designed, and this clear aligner is fabricated. After fabrication is completed, the clear aligner is delivered to the dentist for use in orthodontic treatment of the teeth, and the wire is removed at this stage, thereby beginning the clear-aligner orthodontics.

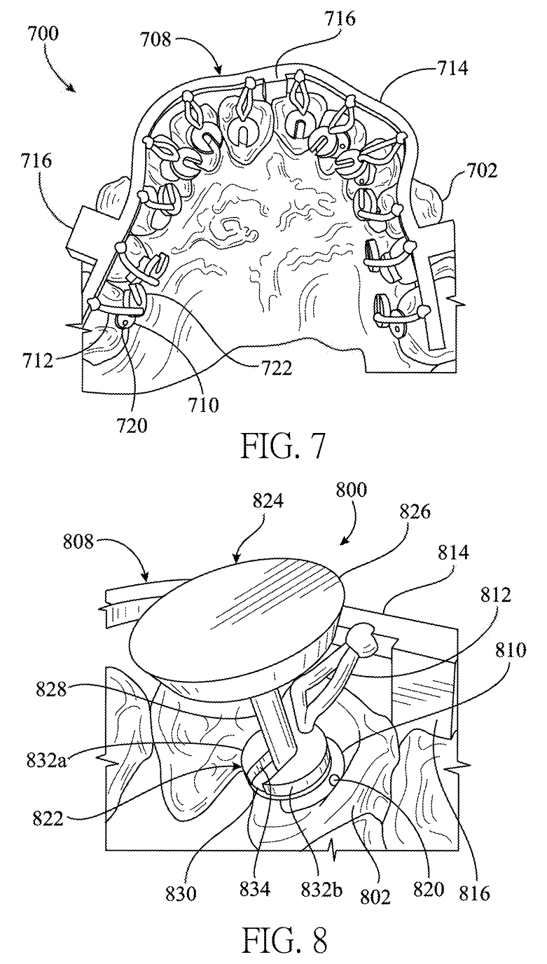

FIG. 7 is a perspective view of the interaction of a dental device 700 with teeth, the dental device 700 being similar to the dental devices 100, 200, 300, 500 and the dental bracket 400 shown in FIGS. 1 to 5. The dental device 700 includes a support member 708, the support member 708 being connected to a dental bracket 710 via an extension 712. The support member 708 includes a beam 714, the beam 714 being connected to the extension 712, and supported by a block 716 arranged on teeth 702. The dental bracket 710 includes a connector 720, the connector 720 being used to interact with a wire (not shown, see for example, the wires 518, 608 shown in FIGS. 5 and 6), and the connector 720 may be similar to the connector 520, the channel 416, and/or the stanchion 318 shown in FIGS. 3 to 5. The structures of the support member 708, the dental bracket 710, the extension 712, the beam 714, and the block 716 may be similar to the support members 108, 208, 308, 508, the dental brackets 110, 210, 310, 400, 510, 610, the extensions 112, 212, 312, 512, the beams 114, 314, 514, and/or the blocks 116, 216, 316, 516 shown in FIGS. 1 to 6.

The dental device 700 includes a guide 722, the guide 722 being used to interact with a cutter (for example, the cutter 824 shown in FIG. 8) or another cutting device or drill, such that the dental bracket 710 can be detached from the extension 712. In certain embodiments, the guide 722 may be disposed on the extension 712, or arranged between the extension 712 and the dental bracket 710, such that when the dental bracket 710 is separated from the extension 712, little or no residual portion of the extension 712 remains on the dental bracket 710. If the dental bracket 710 is precisely cut, the person applying the dental device 700 can easily remove it from the dental bracket 710, without needing to further grind, sand, or remove a portion of the extension 712 remaining on the dental bracket 710. When the guide 722 is not used for cutting, residual extension may be left behind and affect the surface quality of the dental bracket 710. In certain embodiments, the guide 722 may be used to assist the person applying the dental device 700 in adjusting the position of the dental bracket 710 before the user activates the adhesive or finalizes the arrangement of the dental bracket 710. For example, a tool (not shown) or a cutter (for example, the cutter 824 shown in FIG. 8) may be used to interact or connect with the guide 722, without cutting the guide 722 from the extension 712 and/or the dental bracket 710, so as to adjust the dental bracket 710 to a desired position before cutting, before installing the wire, and/or before activating any adhesive.

The guide 722 may be made of any material of sufficient strength, so as to interact with a tool or a cutter, such that the user can adjust the dental bracket 710. For example, the guide 722 may be made of the same material as the support member 708 and/or the dental bracket 710, and may form a continuous portion of the dental device 700. In addition, the guide 722 may also be bonded or connected to the dental bracket 710 and/or the extension 712 after the dental device 700 is formed, such that the user can adjust the position of the guide 722, so as to optimize the cutting effect and/or promote the separation of the dental bracket 710 from the extension 712.

The guide 722 may be arranged in an appropriate position, or used to assist the user in cutting and/or separating the dental bracket 710 from any direction relative to the gums. For example, the user may wish to cut from a side of the gums (for example, FIG. 8), a side of the teeth 702, or a side of the dental bracket 710 (i.e., in a direction towards another dental bracket 710), and the guide 722 may be correspondingly arranged, so as to assist the user in achieving the desired cutting direction. In certain embodiments, the guide 722 may include an opening (not shown) or other structural feature, such that it can rotate about the extension 712, thereby assisting the user in adjusting the dental bracket 710 and/or separating it from the extension 712 in any direction.

FIG. 8 is a perspective view of a dental device 800, which may be similar to the dental devices 100, 200, 300, 500, 700 and the orthodontic appliance 600 shown in FIGS. 1 to 3 and 5 to 7, and is engaged with teeth 802. The dental device 800 includes a support member 808, the support member 808 being connected to a dental bracket 810 via an extension 812. The support member 808 further includes a beam 814, the beam 814 being connected to the extension 812, and supported by a block 816 arranged on the teeth 802. The dental bracket 810 includes a connector 820, the connector 820 being used to engage with a wire (not shown, see the wires 518, 608 of FIGS. 5 to 6), and the connector 820 may be similar to the connector 520, the channel 416, and/or the stanchion 318 shown in FIGS. 3 to 5. The structures of the support member 808, the dental bracket 810, the extension 812, the beam 814, and the block 816 may be similar to the support members 108, 208, 308, 508, 708, the dental brackets 110, 210, 310, 400, 510, 610, 710, the extensions 112, 212, 312, 512, 712, the beams 114, 314, 514, 714, and/or the blocks 116, 216, 316, 516, 716 shown in FIGS. 1 to 5 and 7. In addition, the dental device 800 further includes a guide 822, the guide 822 being similar to the guide 722 shown in FIG. 7.

As shown in FIG. 8, a cutter 824 is shown physically separate from the dental device 800 (but may be included as part of a component kit or 3D mold of the dental device 800). The cutter 824 is used to separate the dental bracket 810 from the extension 812, and may be used manually by a user, an automatic machine, a controllable machine, a robot, or any combination thereof. The cutter 824 may have any configuration suitable for cutting the dental bracket 810 from the dental device 800, and may be designed to cooperate with the guide 822, such that the user can quickly and efficiently separate the dental bracket 810 from the dental device 800. The cutter 824 may have an appropriate size, so as to ensure that when the dental bracket 810 is applied to the inner side or outer side of the teeth 802, the cutter 824 can be placed within the oral cavity of the user. In certain embodiments, the cutter 824 or a portion thereof may be integrated with the dental device 800, such that it forms a continuous portion of the dental device 800. In other embodiments, the cutter 824 may be assembled from a plurality of components, wherein one or more of a handle 826, a post 828, and a blade 830 are bonded together or integrally formed.

The guide 822 includes a pair of appendages 832a, 832b, the pair of appendages 832a, 832b defining a pathway 834, the pathway 834 being used to contact and interact with the post 828 and the blade 830, so as to cause the user to cut the dental bracket 810 from the extension 812. In certain embodiments, one or more pairs of appendages 832a, 832b (for example, two to eight appendages) may be used to interact with one or more posts 828 connected to the blade 830. The appendages 832a, 832b may have an appropriate angle, so as to accommodate the post 828, the blade 830, and/or any other tool used to adjust the dental bracket 810 and/or to cut the dental bracket 810 from the respective extension 812.

The appendages 832a, 832b may have any shape sufficient to accommodate the blade 830 and/or the post 828. For example, the appendages 832a, 832b may be arranged in parallel, such that the pathway 834 has a uniform width from a center to an end. In certain embodiments, the width of the appendages 832a, 832b is larger than the width of the post 828, such that the user can more easily guide the post 828 and/or the blade 830 towards the dental bracket 810 and/or the extension 812. In certain embodiments, the appendages 832a, 832b may have an arc-shaped or crescent-shaped structure, wherein the ends of the structure extend inward, so as to prevent the post 828 from accidentally slipping out of the pathway 834. In certain embodiments, the appendages 832a, 832b may have a straight-line, arc-shaped, or crescent-shaped structure, wherein the ends of the structure extend outward, so as to form a tapered pathway 834, such that the post 828 is more easily introduced into the pathway 834. In certain embodiments, the appendages 832a, 832b may form a closed loop structure, such that the pathway 834 forms a guiding mechanism, allowing the blade 830 to be guided along the pathway 834 to the dental bracket 810, and to precisely cut the connection between the dental bracket 810 and the extension 812. The appendages 832a, 832b may adopt any appropriate configuration, so as to ensure that the pathway 834 can effectively receive the blade 830 and/or the post 828.

The handle 826 is used to provide a component, such that the user can manually operate the cutter 824. The handle 826 may have any appropriate configuration, so as to assist in operating the cutter 824. For example, the handle 826 may be circular, square, triangular, or any shape suitable for the user to grip. In certain embodiments, the handle 826 may include a rubber or anti-slip textured portion, so as to enhance the user's grip on the cutter 824.

The post 828 is used to provide a leverage force, such that the blade 830 penetrates the extension 812, and separates the dental bracket 810 from the support member 808. The post 828 may have any appropriate length, so as to assist in providing leverage on the cutter 824, and to allow the user to operate the cutter 824 within the oral cavity of the user. The post 828 may have any shape, and extends between the blade 830 and the handle 826, for example, cylindrical, square, rectangular, or any other appropriate shape. In certain embodiments, the post 828 may double as the handle 826, and the dental device 800 does not include the handle 826 as shown in FIG. 8. The post 828 may have a sufficient length, such that the user can grip the post 828 and/or the handle 826, and rotate the blade 830 relative to the dental bracket 810, so as to cut and separate the dental bracket 810 from the extension 812, without interference by one or more teeth 802.

The blade 830 is used to directly contact and separate the dental bracket 810 from the extension 812 of the dental device 800. The blade 830 may have any appropriate configuration, so as to cut the dental bracket 810 and separate it from the extension 812. For example, the blade 830 may be disc-shaped, square, triangular, rectangular, or any combination thereof. The blade 830 may be made of any appropriate material, so as to separate the extension 812 from the dental bracket 810. The blade 830 may be composed of a variety of materials or components, so as to provide leverage during cutting, and to effectively separate the extension 812 from the dental bracket 810. For example, the blade 830 may be made of diamond, stainless steel, tungsten carbide, stellite alloy, ceramic, cubic boron nitride, or any combination thereof. The blade 830 may be sharpened to an appropriate angle, so as to effectively cut the extension 812, such that no excess portion of the extension 812 remains on the dental bracket 810, thereby avoiding the use of grinding, sanding, or other additional processing techniques to remove excess material.

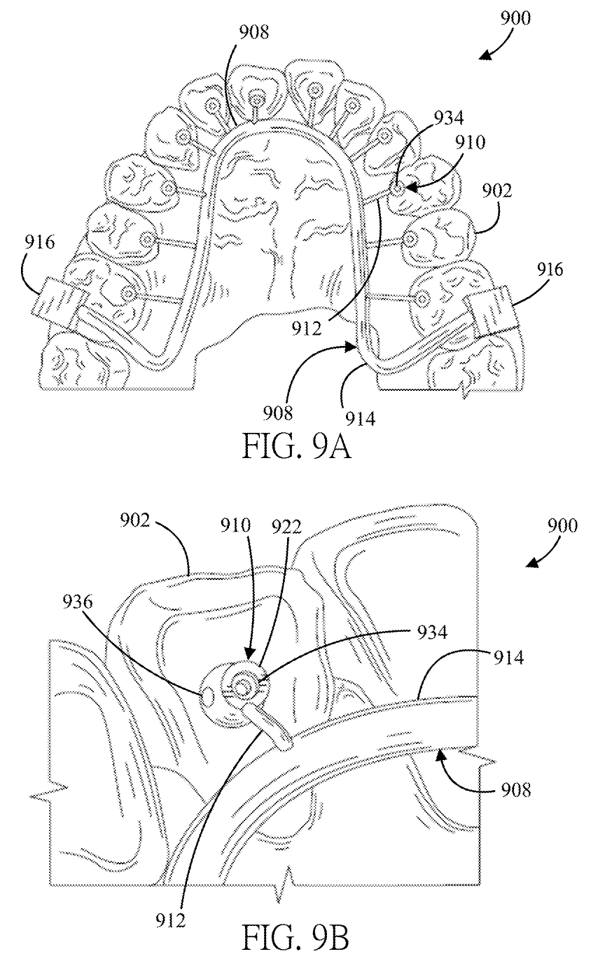

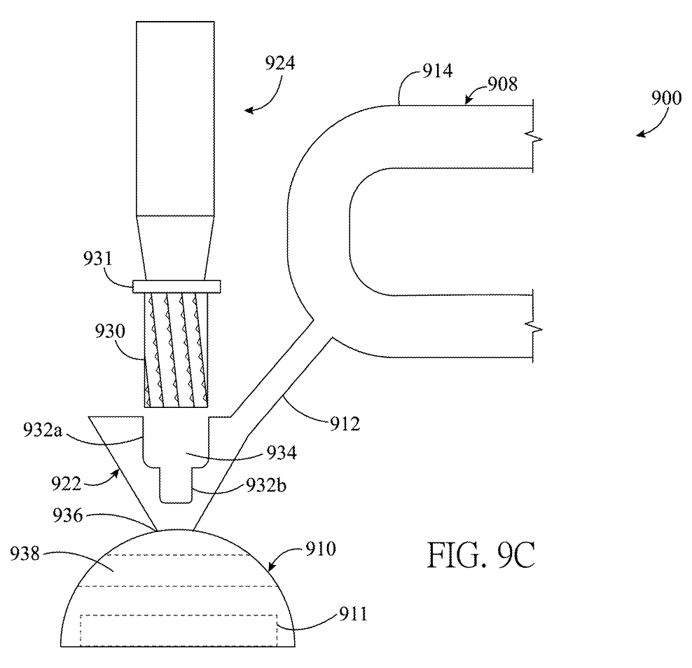

FIG. 9A is a perspective view of a dental device 900, which may be similar to the dental devices 100, 200, 300, 500, 700, 800 and the orthodontic appliance 600 shown in FIGS. 1 to 3 and 5 to 8. FIG. 9B is a perspective view of the dental device 900 of FIG. 9A, presenting an enlarged view of a dental bracket 910 connected to a support member 908. FIG. 9C is a cross-sectional view of the dental device 900 used together with a drill 924, the drill 924 having a function similar to that of the cutter 824 shown in FIG. 8.

The dental device 900 includes a support member 908 connected to a dental bracket 910 via an extension 912, the support member 908 being similar to the support members 108, 208, 308, 508, 708, 808 shown in FIGS. 1 to 8; the dental bracket 910 being similar to the dental brackets 110, 210, 310, 400, 510, 610, 710, 810 shown in FIGS. 1 to 8; the extension 912 being similar to the extensions 112, 212, 312, 512, 712, 812 shown in FIGS. 1 to 8; the block 916 being similar to the blocks 116, 216, 316, 516, 716, 816 shown in FIGS. 1 to 3, 5, 7, and 8. The extension 912 is connected to the support member 908 via a beam 914, the beam 914 being similar to the beams 114, 314, 514, 714, 814 shown in FIGS. 1, 3, 5, 7, and 8. The dental bracket 910 has at least one cutout 911, the cutout 911 being similar to the cutout 406 shown in FIG. 4A, and the dental bracket 910 is connected to the extension 912 via a guide 922. The guide 922 is used to guide the drill 924, so as to promote the separation of the dental bracket 910 from the support member 908. The guide 922 has an opening 932a, the size of which is equal to or larger than the drill 924, and a subsequent opening 932b, the size of which is equal to or smaller than the opening 932a, and equal to or smaller than the drill 924. When a drill head 930 passes through a pathway 934 defined by the openings 932a, 932b, the drill 924 will remove the material of the guide 922, until the drill head 930 contacts a terminal edge 936 of the guide 922.

When the drill head 930 contacts, drills through, or removes the terminal edge 936 or a position adjacent thereto, the dental bracket 910 is separated from the guide 922. This configuration allows the user to precisely position the dental bracket 910 on a tooth 902, and to separate the dental bracket 910 from the dental device 900 with high precision, reducing the risk of interference with other portions of the oral cavity and/or the dental device 900, and avoiding drilling into a channel 938, the channel 938 being similar to the channel 416 shown in FIGS. 4A to 4B.

A stopper 931 may be provided above the drill head 930 of the drill 924, so as to prevent or reduce the drill head 930 from drilling through the terminal edge 936 and into the channel 938. The size of the stopper 931 may be larger than the opening 932a. In certain embodiments, the drill 924 may not include the stopper 931. The width of the terminal edge 936 is smaller than the drill head 930, such that when the drill head 930 moves into contact with the terminal edge 936 or a position adjacent thereto, the drill 924 can remove sufficient material, so as to separate the dental bracket 910 from the guide 922.

The drill 924 may have any configuration suitable for separating the dental bracket 910 from the dental device 900. The drill 924 may be used to interact with one to ten openings 932a, 932b, and the widths of these openings 932a, 932b may progressively narrow, such that the user can be smoothly guided from a top of the guide 922 to the terminal edge 936 of the guide 922. In certain embodiments, the guide 922 may include an opening (not shown), and the opening may have a tapered structure, so as to guide the drill 924 towards the terminal edge 936. The drill 924 and its drill head 930 may have any configuration known in the art that is suitable for drilling through organic and inorganic materials (for example, metal, ceramic, polymer material, and/or composite material). For example, the drill head 930 may have an inclined or sharp shape, such that the drill head 930 is more easily guided through a particular material and the openings 932a, 932b. In this specification, when describing the separation of the dental bracket 910 from the dental device 900, the term "drilling" may be used interchangeably with "cutting."

The guide 922 may have any configuration sufficient to assist in drilling from the top to the terminal edge 936. FIG. 9C shows a tapered and/or stepped structure, such that the drill 924 can drill to a position where its width is larger than the terminal edge 936. Any configuration is applicable, as long as it can enable the drill 924 to remove sufficient material so as to separate the dental bracket 910 from the guide 922. In certain configurations, the terminal edge 936 may be arranged along an axis coaxial with the pathway 934, such that the drill 924 can be directly guided along the openings 932a, 932b and the pathway 934 to the terminal edge 936, so as to effectively separate the dental bracket 910 from the guide 922.

The pathway 934 serves as a guiding passage, so as to accommodate the drill head 930. The pathway 934 may have any size or shape, as long as it is sufficient to accommodate a respective drill 924. The size or length of the pathway 934 may be appropriately designed, such that the drill head 930 can enter and remove the material of the guide 922, until the guide 922 is separated from the dental bracket 910, with little or no material remaining on the dental bracket 910.

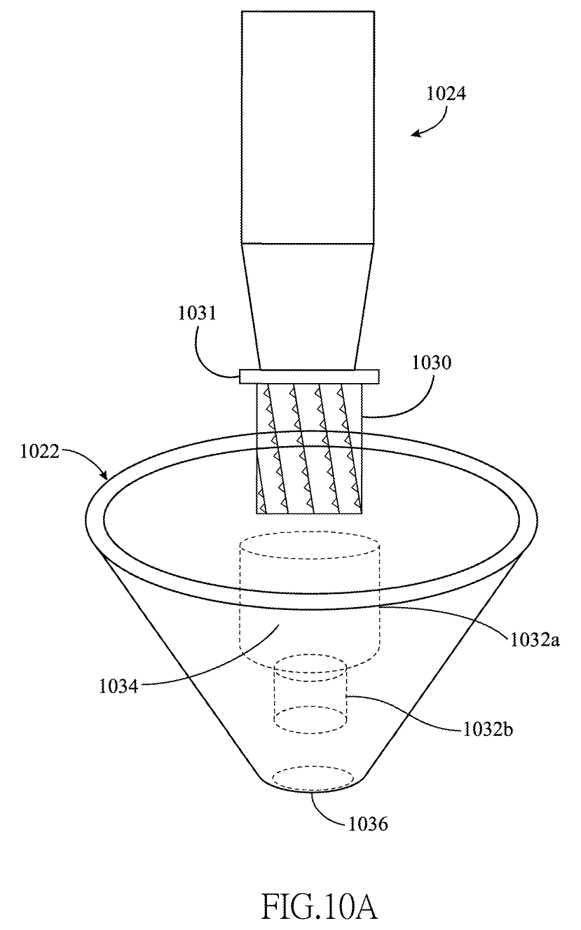

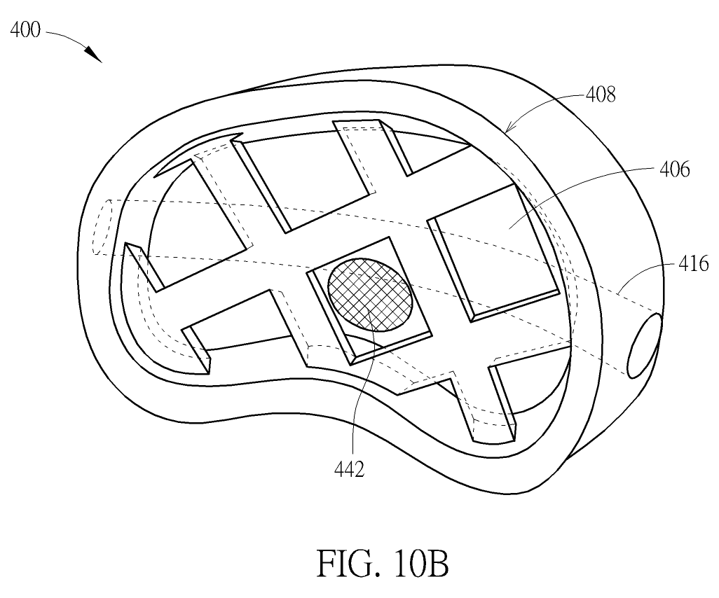

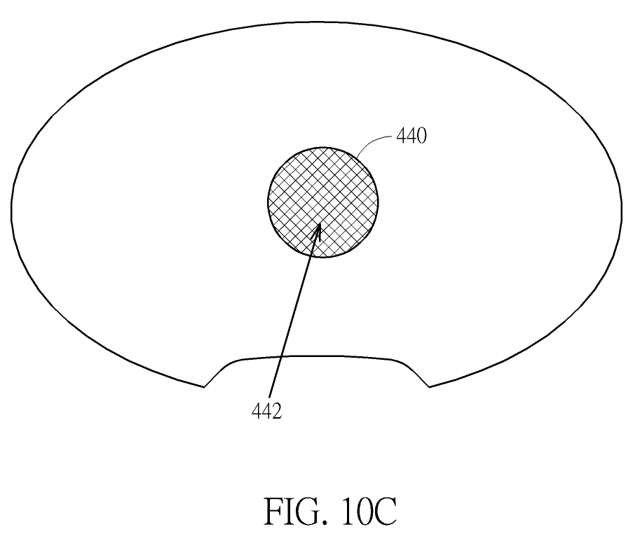

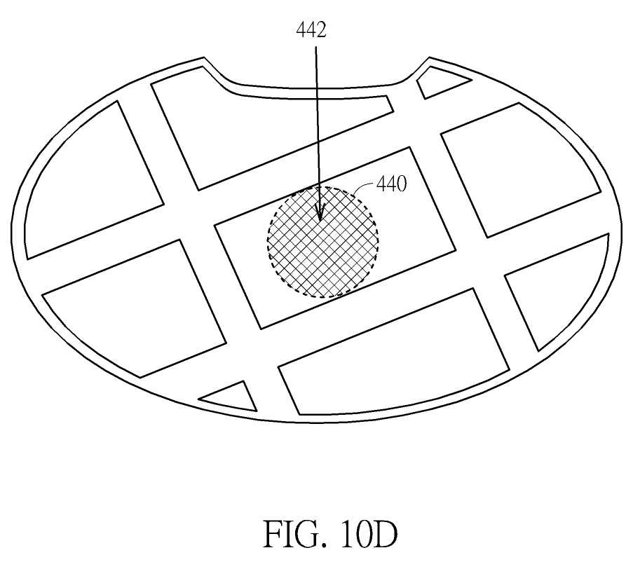

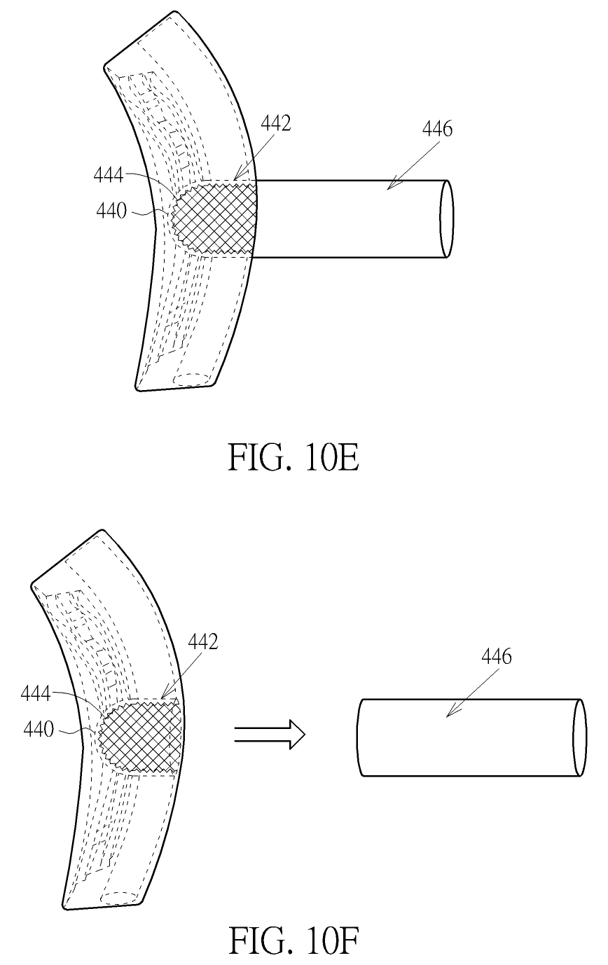

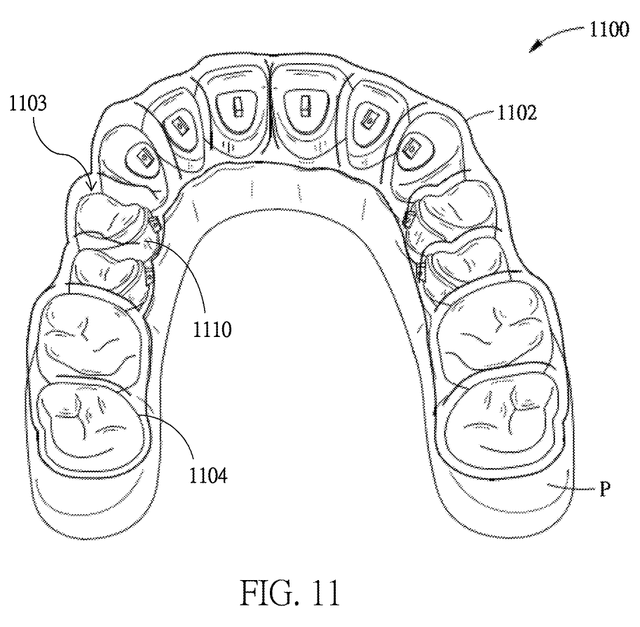

FIG. 10A is a perspective view of a guide 1022, the guide 1022 being transparent and in a position for drilling by a drill 1024, the guide 1022 and the drill 1024 being similar to the guide 922 and the drill 924 shown in FIGS. 9A to 9C. The drill 1024 includes a drill head 1030, the drill head 1030 being used to interact with the guide 1022, and to pass through openings 1032a, 1032b, so as to drill towards a terminal edge 1036 of the guide 1022, the openings 1032a, 1032b, the drill head 1030, and the terminal edge 1036 being similar to the openings 932a, 932b, the drill head 930, and the terminal edge 936 shown in FIGS. 9A to 9C. As shown in FIG. 10A, a second opening 1032b is separated from the terminal edge 1036 by a solid portion of the guide 1022, and the drill 1024 is used to penetrate the guide 1022 and remove material during the drilling process. The drill 1024 includes a stopper 1031, the stopper 1031 being disposed above the drill head 1030, and may be similar to the stopper 931 shown in FIGS. 9A to 9C, and being used to prevent the drill head 1030 from drilling too deep, so as to avoid unintended interaction with one or more dental brackets (for example, the dental bracket 910 shown in FIGS. 9A to 9C).

The openings 1032a, 1032b define a pathway 1034, which may have any appropriate configuration, so as to guide the drill 1024 through the guide 1022 and towards the terminal edge 1036 adjacent to a dental bracket (not shown). For example, the openings 1032a, 1032b defining the pathway 1034 should have a sufficient width, so as to interact with the drill head 1030. The width of a first opening 1032a may be similar to the width of the drill head 1030 (differing by 1 to 100 micrometers). The width of a second opening 1032b may be smaller than the width of the drill head 1030, such that the drill head 1030 can remove material at the second opening 1032b, and be guided to the terminal edge 1036. The guide 1022 may include a plurality of openings 1032a, 1032b, so as to ensure that the drill 1024 can be effectively guided towards the terminal edge 1036.

The terminal edge 1036 may have an appropriate width, so as to allow the drill 1024 to separate the guide 1022 from a dental bracket (not shown). For example, the width of the terminal edge 1036 may be the same as or smaller than the width of the drill head 1030. The terminal edge 1036 may be connected to a dental bracket (not shown) by any appropriate manner, for example, by an adhesive or welding. In certain embodiments, the guide 1022 and a dental bracket (not shown) may be integrally formed, and may be fabricated through techniques described herein or well known in the art. In certain embodiments, a dental bracket (not shown) and the guide 1022 are simultaneously formed through a 3D printing process.

FIG. 10A provides one manner of separating a dental bracket from an extension, namely, separating the dental bracket from the extension by directing a drill 1024 with a guide 1022 to cut the extension. FIGS. 10B–10F provide another manner of separating a dental bracket from an extension. FIG. 10B is a back view of another embodiment of a dental bracket 400 similar to FIG. 4A, showing a recess 440 filled with a weakened portion 442 further formed in the dental bracket 400; FIG. 10C is a bottom view of the dental bracket 400 of FIG. 10B; FIG. 10D is a top view of the dental bracket 400 of FIG. 10B; FIG. 10E is a schematic structural view of the dental bracket 400 of FIG. 10B integrally formed with an extension 446, wherein the dental bracket 400 and the extension 446 are maintained connected to each other through the weakened portion 442; and FIG. 10F is a schematic structural view of the dental bracket 400 of FIG. 10B after the extension 446 is separated therefrom, wherein the weakened portion 442 remains in the recess 440 and the extension 446 has been separated from the weakened portion 442. The structure of the dental bracket 400 of FIGS. 10B–10F may refer to the dental bracket 400 of FIG. 4A described above, wherein the same elements are denoted by the same reference numerals, and the dental bracket 400 may be applied to the dental devices 100, 200, 300 shown in FIGS. 1–3. The dental bracket 400 includes a front surface 414 and a back surface 408, with a passage 416 disposed between the front surface 414 and the back surface 408. The passage 416 extends through the holes 404a, 404b such that an archwire (e.g., the archwire 518 of FIG. 5) can pass therethrough to securely fix an orthodontic appliance to a tooth surface (not shown). The passage 416 is disposed behind the notch 406 to maximize the internal volume of the notch 406.

Specifically, compared to the dental bracket 400 of FIG. 4A described above, the dental bracket 400 of FIGS. 10B–10F further includes a recess 440 disposed in the front surface 414, with a weakened portion 442 disposed in the recess 440. The weakened portion 442 connects the dental bracket 400 with an extension 446 (e.g., the extensions 112, 212, 312 of FIGS. 1–3), such that the dental bracket 400 is supported at a predetermined position through the extension 446. The weakened portion 442 is configured to be more easily broken or separated than other portions of the dental bracket 400 and the extension 446, such that the extension 446 can be separated from the dental bracket 400 at the weakened portion 442, while the weakened portion 442 remains in the recess 440 in the front surface 414 of the dental bracket 400. Although FIGS. 10B–10F show only one recess 440 and one weakened portion 442, in some embodiments the dental bracket 400 may include a plurality of recesses 440 and a plurality of weakened portions 442 in the front surface 414, with each of the plurality of weakened portions 442 connected to a respective extension 446. Furthermore, although FIGS. 10B–10F illustrate the recess 440 and the weakened portion 442 as being located at a central portion of the front surface 414 of the dental bracket 400, the present disclosure is not limited thereto; the recess 440 and the weakened portion 442 may be located at any region of the front surface 414 of the dental bracket 400, and their position may be adjusted according to the user's oral structure.

In at least one embodiment of the present disclosure, the weakened portion 442 includes an anchor 444, the anchor 444 being a protruding or spike-shaped structure formed at the junction between the dental bracket 400 and the extension 446, such that the junction forms an embrittled and breakable structure. In some embodiments, the weakened portion 442 may have a semi-hollow structure rather than a completely solid structure, such that a density of the weakened portion 442 differs from a density of a portion of the dental bracket 400 surrounding the recess 440. Through the configuration of the anchor 444 and/or the semi-hollow structure, the connection between the dental bracket 400 and the extension 446 is weaker than other portions, facilitating separation of the extension 446 from the dental bracket 400 at the weakened portion 442. The dental bracket 400 may include any number of anchors 444 and/or weakened portions 442 to adjust the connection strength between the dental bracket 400 and the extension 446.

In at least one embodiment of the present disclosure, the dental bracket 400, the weakened portion 442, and the extension 446 are integrally formed through a 3D printing process, such that the dental bracket 400, the weakened portion 442, and the extension 446 form a single continuous structure. During the 3D printing process, the anchor 444 and/or the semi-hollow structure of the weakened portion 442 is deliberately formed at the junction between the dental bracket 400 and the extension 446, so as to form a frangible structure at the junction that is more easily broken than other portions. As shown in FIG. 10E, the dental bracket 400 and the extension 446 are integrally formed and maintained connected to each other through the weakened portion 442, awaiting subsequent breaking and removal of the extension 446.

In another embodiment, the constitution of the weakened portion 442 is not limited to being integrally formed. The essence of the weakened portion 442 lies in that a frangible connecting layer that is more easily broken than other portions of the dental bracket 400 and the extension 446 is provided between the dental bracket 400 and the extension 446, such that the extension 446 can be separated from the dental bracket 400 at the frangible connecting layer, and the manner of forming it need not be integral formation. In some embodiments, the weakened portion 442, the dental bracket 400, and the extension 446 are integrally printed through a 3D printing process, so as to integrally form, at the junction, the frangible connecting layer having the anchor 444 and/or the semi-hollow structure. In some other embodiments, the weakened portion 442 may alternatively not be integrally formed with the dental bracket 400 and the extension 446, but may be formed as a coating at the junction between the dental bracket 400 and the extension 446 through a chemical process, so as to serve as the frangible connecting layer. For example, the dental bracket 400 and the extension 446 may be separately pre-manufactured, and a coating layer may then be formed at the junction therebetween by chemical plating, chemical vapor deposition, dip coating, coating film formation, or other chemical coating methods, such that the coating layer constitutes the frangible connecting layer connecting the dental bracket 400 and the extension 446; a material, a thickness, and/or a bonding strength of the coating layer is configured to be more easily broken than other portions of the dental bracket 400 and the extension 446, such that the extension 446 can be separated from the dental bracket 400 at the coating layer. By making the manner of forming the weakened portion 442 not limited to integral formation but rather being either integral printing or chemical coating, the dental bracket 400 can have a broader range of implementations.

After a dental device (e.g., the dental devices 100, 200, 300 of FIGS. 1–3) is placed into a user's oral cavity and the dental bracket 400 is fixed to a respective tooth, the extension 446 can be separated from the dental bracket 400 at the weakened portion 442, such that the extension 446, together with the support member connected thereto, can be removed from the oral cavity, while the dental bracket 400 remains fixed to the tooth. In some embodiments, the extension 446 may be broken off directly by hand at the weakened portion 442. In other embodiments, the extension 446 may also be separated from the dental bracket 400 at the weakened portion 442 by applying a mechanical force, or by chemical solvent treatment, heating, or ultraviolet irradiation. As shown in FIG. 10F, after the extension 446 is separated, the weakened portion 442 remains in the recess 440 in the front surface 414 of the dental bracket 400 and is structurally observable. That is, the dental bracket 400 fixed to the tooth retains, in the recess 440 of the front surface 414, the weakened portion 442 having the anchor 444 and/or the semi-hollow structure. Compared to FIG. 10A, in which the dental bracket is separated from the extension by directing the drill 1024 with the guide 1022 to cut the extension, FIGS. 10B–10F separate the extension 446 from the dental bracket 400 by breaking the weakened portion 442; thus, FIG. 10A and FIGS. 10B–10F provide two different manners of separating a dental bracket from an extension.

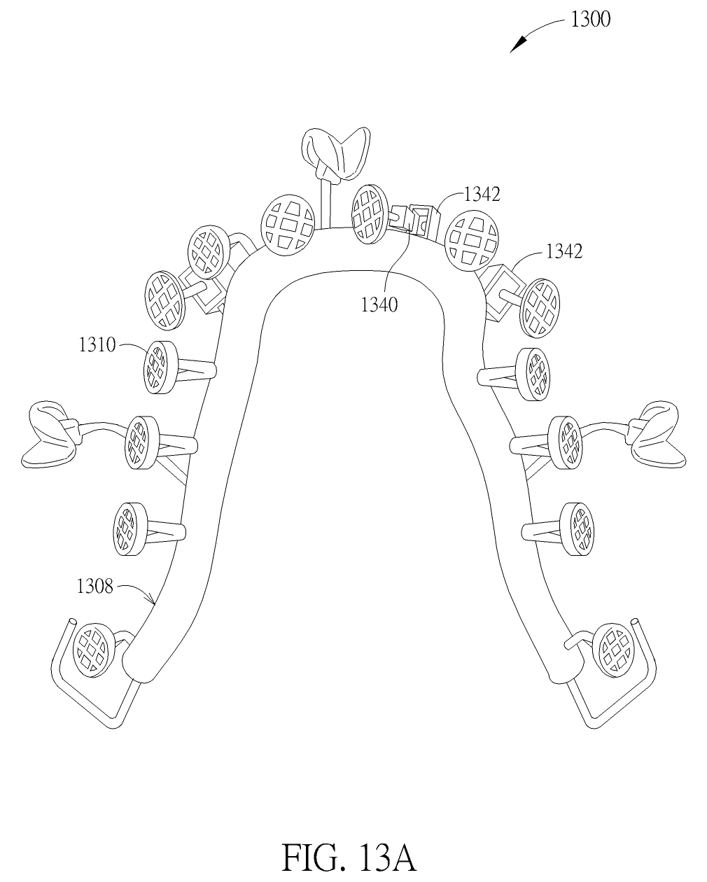

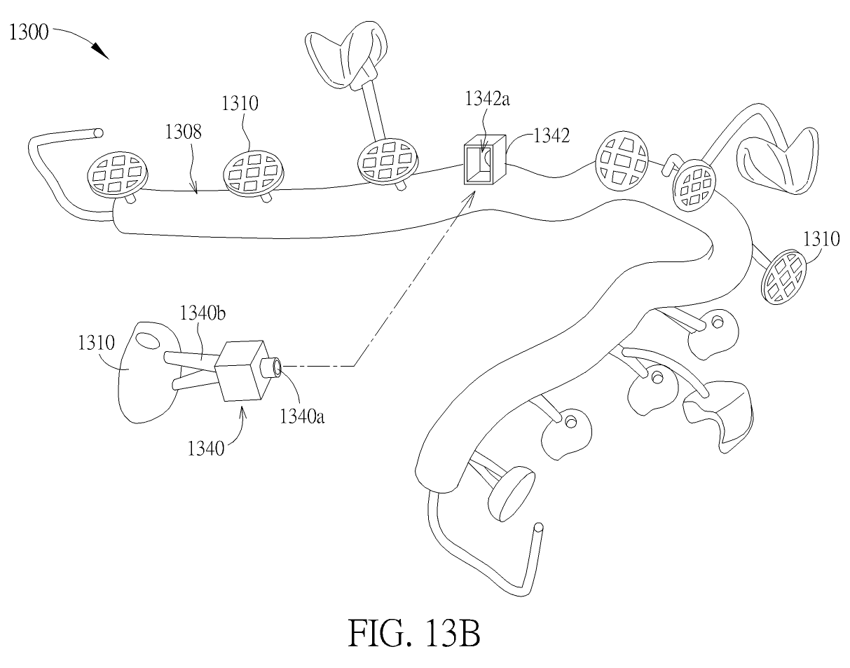

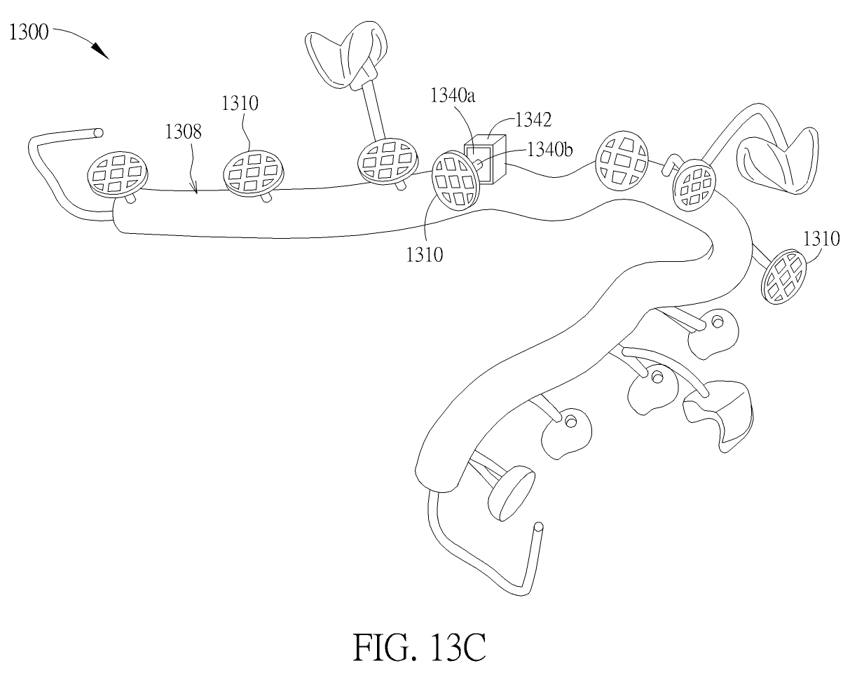

It should be noted that the configuration of the recess 440 and the weakened portion 442 of the present embodiment differs from the insertion-type configuration of the insertion portion 1340 and the receiving member 1342 shown in FIGS. 13A–13C below. In the present embodiment, the weakened portion 442 connects the dental bracket 400 and the extension 446 as a frangible structure, and after the extension 446 is separated, the weakened portion 442 remains in the recess 440 of the dental bracket 400. Although FIGS. 10B–10F are described only with respect to the dental bracket 400 of FIG. 4A, those skilled in the art will appreciate that the foregoing configuration of the recess 440, the weakened portion 442, and the anchor 444 may also be applied to the dental brackets 110, 210, 310 of FIGS. 1–3 or to dental brackets in other embodiments of the present disclosure.

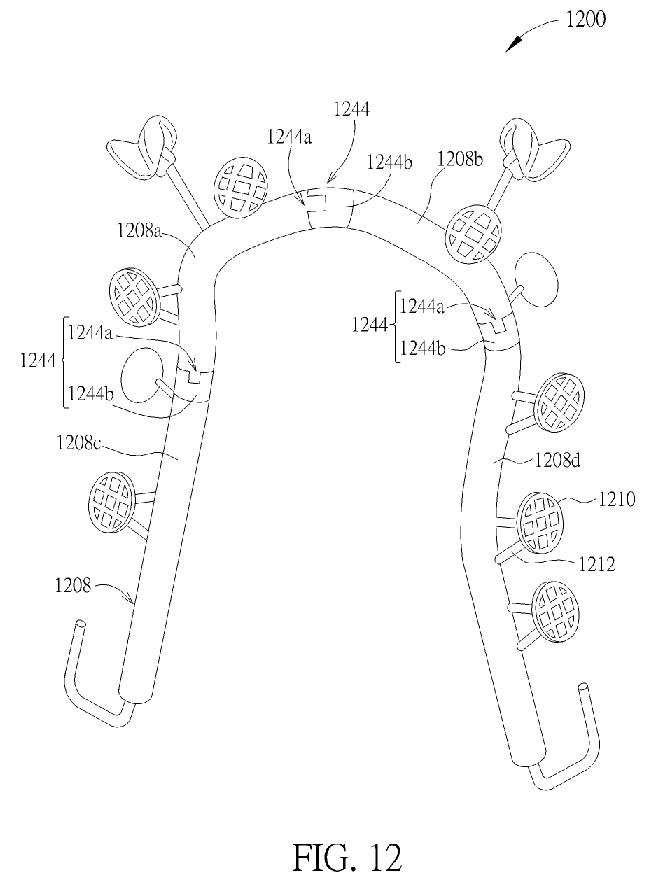

FIG. 12 is a perspective view of another example of a dental device 1200, the dental device 1200 being similar to the dental devices 100, 200, 300, 500, 700, 800, 900 and the orthodontic appliance 600 shown in FIGS. 1 to 3 and 5 to 9. The dental device 1200 includes a support member 1208, the support member 1208 being connected to a dental bracket 1210 via an extension 1212. The structures of the support member 1208, the dental bracket 1210, and the extension 1212 may be similar to the support members 108, 208, 308, 508, 708, 808, 908, the dental brackets 110, 210, 310, 400, 510, 610, 710, 810, 910, and/or the extensions 112, 212, 312, 512, 712, 812, 912 shown in FIGS. 1 to 9.

As shown in FIG. 12, the support member 1208 includes a plurality of segments 1208a, 1208b, 1208c, 1208d arranged along an arch shape. In the illustrated embodiment, the support member 1208 includes a left front section 1208a, a right front section 1208b, a left rear section 1208c, and a right rear section 1208d, respectively corresponding to respective regions of the oral cavity of the user. Each of the segments 1208a, 1208b, 1208c, 1208d respectively carries at least one dental bracket 1210, and each dental bracket 1210 is connected to the segment via at least one respective extension 1212, so as to support the dental bracket 1210 in a predetermined position.

By configuring the support member 1208 as a plurality of segments 1208a, 1208b, 1208c, 1208d, the interference with other oral structures when the dental device 1200 is introduced into the oral cavity can be reduced, and segmented fabrication and local replacement are facilitated. For example, when any one of the segments 1208a, 1208b, 1208c, 1208d produces a defect during the fabrication process, only that segment needs to be re-fabricated, without needing to re-fabricate the entire support member 1208, thereby reducing fabrication cost. In addition, since each of the segments 1208a, 1208b, 1208c, 1208d can independently enter and be positioned within the oral cavity, the dentist can install the dental brackets 1210 segment by segment, so as to improve the precision and convenience of the application.

In certain embodiments, adjacent segments 1208a, 1208b, 1208c, 1208d can be separated from each other, such that each of the segments 1208a, 1208b, 1208c, 1208d can respectively enter the oral cavity and be independently positioned in a respective tooth region. Through this configuration, the problem that the entire support member 1208 is not easily placed into the oral cavity at one time due to its larger size can be avoided, and the interference of the support member 1208 with the teeth, gums, tongue, or other oral structures when introduced into the oral cavity can be reduced. In other embodiments, adjacent segments 1208a, 1208b, 1208c, 1208d may be connected to each other via a latch structure 1244. The latch structure 1244 may include a tenon 1244a disposed at an end portion of one segment, and a mortise 1244b disposed at an end portion of an adjacent other segment, wherein a shape of the tenon 1244a corresponds to the mortise 1244b, such that the tenon 1244a can be inserted into the mortise 1244b, so as to detachably engage the adjacent segments with each other. When the latch structure 1244 is configured to be detachable, the dentist can first place each of the segments 1208a, 1208b, 1208c, 1208d into the oral cavity respectively, and then connect the adjacent segments to each other within the oral cavity via the latch structure 1244, such that the support member 1208 forms a continuous structure extending along the dental arch, so as to facilitate the alignment and application of the dental brackets 1210. Conversely, after the application of the dental brackets 1210 is completed, the dentist can first detach the latch structure 1244 within the oral cavity, such that the support member 1208 is separated into a plurality of segments 1208a, 1208b, 1208c, 1208d, and then remove each segment from the oral cavity respectively. Thereby, both the placement and removal of the support member 1208 can be performed in a segmented manner, thereby improving the convenience of clinical operation and reducing patient discomfort. In certain embodiments, the cooperation of the tenon 1244a with the mortise 1244b may be an interference fit, so as to enhance the engagement strength of the adjacent segments, and to reduce the possibility of the support member 1208 accidentally loosening or relatively displacing during the application of the dental brackets 1210.

The number and extent of the segments 1208a, 1208b, 1208c, 1208d may be adjusted according to the configuration of the user's teeth. For example, the support member 1208 may include two, three, four, five, or more segments. Each of the segments may respectively correspond to one region of the oral cavity of the user, for example, a left posterior tooth region, a right posterior tooth region, a left anterior tooth region, a right anterior tooth region, an upper jaw front section, a lower jaw front section, or other appropriate regions. In certain embodiments, the boundary of a segment may be located between a canine tooth and a premolar tooth, or located between a premolar tooth and a molar tooth, so as to facilitate independent application of a segment without affecting the orthodontic effect of adjacent teeth.

Each of the segments 1208a, 1208b, 1208c, 1208d may be fabricated at one time from a continuous material and have the same material, and may be fabricated through any suitable process, for example, 3D printing, injection molding, assembly, or any combination thereof. Alternatively, each of the segments 1208a, 1208b, 1208c, 1208d may also be made of a different material. For example, the segments 1208b, 1208a may be made of a material having higher malleability, so as to facilitate adjustment and alignment during installation; while the rear sections 1208c, 1208d may be made of a material having higher rigidity, so as to enhance the stability of the overall structure.

FIG. 13A is a perspective view of another example of a dental device 1300. The dental device 1300 may be similar to the dental devices 100, 200, 300, 500, 700, 800, 900, 1200 and the orthodontic appliance 600 shown in FIGS. 1 to 3 and 5 to 9 and 12. The dental device 1300 includes a support member 1308 and a plurality of dental brackets 1310, each of the dental brackets 1310 being used to be secured to a respective tooth. The structures of the support member 1308 and the dental brackets 1310 may be similar to the support members 108, 208, 308, 508, 708, 808, 908, 1208, and the dental brackets 110, 210, 310, 400, 510, 610, 710, 810, 910, 1210 shown in FIGS. 1 to 9 and 12.

As shown in FIG. 13A, the support member 1308 includes a plurality of receiving members 1342, and the dental brackets 1310 respectively include respective insertion portions 1340. That is, the dental device 1300 includes a plurality of sets of mutually corresponding insertion portions 1340 and receiving members 1342, and the insertion portion 1340 and the receiving member 1342 of each set respectively correspond to a respective dental bracket 1310. The insertion portion 1340 of each of the dental brackets 1310 extends from the dental bracket 1310 towards the support member 1308, and is engaged with a respective receiving member 1342, such that the dental bracket 1310 is supported in a predetermined position through the engagement of the receiving member 1342 with the insertion portion 1340.

Through the foregoing configuration, the position of each of the dental brackets 1310 on the support member 1308 can be independently adjusted. For example, before or after placing the dental device 1300 into the oral cavity, the dentist can individually adjust the position or angle of any one dental bracket 1310 relative to the support member 1308, without needing to simultaneously adjust the other dental brackets 1310, thereby improving the precision of the application. In addition, since each of the dental brackets 1310 can be independently adjusted, when a wire (for example, the wire 518 shown in FIG. 5) is threaded through the connectors of the dental brackets 1310, the dentist can fine-tune the position of each of the dental brackets 1310 one by one, such that the wire can be more smoothly threaded through and aligned with the connector of each of the dental brackets 1310, thereby improving the convenience of threading the wire.

FIG. 13B is a partial enlarged view of the dental device 1300 of FIG. 13A, showing a state in which the insertion portion 1340 of one dental bracket 1310 is separated from the respective receiving member 1342 of the support member 1308. As shown in FIG. 13B, the insertion portion 1340 includes a body 1340a and at least one support stem 1340b extending from the body 1340a, the at least one support stem 1340b being connected to a body of the dental bracket 1310. The body 1340a may be block-shaped, columnar, rectangular, polygonal, or any combination thereof, so as to engage with the receiving member 1342. In the illustrated embodiment, the body 1340a is block-shaped, and has a plurality of support stems 1340b extending from the body 1340a to the dental bracket 1310. In other embodiments, the number of support stems 1340b may be one, two, three, or more, so as to enhance the connection strength between the insertion portion 1340 and the dental bracket 1310.

The receiving member 1342 may include an opening 1342a for accommodating the body 1340a. The opening 1342a may be square, rectangular, circular, polygonal, or any combination thereof, and have an appropriate size and depth, so as to accommodate the body 1340a. The receiving member 1342 may be connected to the support member 1308, and may be arranged at an appropriate position on the support member 1308 according to the positional needs of the dental bracket 1310, the insertion portion 1340, or a respective tooth. For example, the receiving member 1342 may be located above, below, on a side of, at an end of, on an inner side surface of, on an outer side surface of, or at another position of the support member 1308 suitable for engaging with the insertion portion 1340. By adjusting the position of the receiving member 1342 on the support member 1308, the dental bracket 1310 can be maintained in a predetermined direction and at a predetermined height relative to the support member 1308, and the dentist is facilitated in performing alignment before or during the application. In certain embodiments, the receiving member 1342 may be integrally formed with the support member 1308, so as to enhance the overall structural strength and reduce assembly steps. In other embodiments, the receiving member 1342 may also be an independent member, and be secured to the support member 1308 by bonding, snap-fitting, fitting, welding, locking, or any combination thereof, such that the receiving member 1342 can be customized according to the dentition form of different patients or the configuration needs of different dental brackets 1310.

FIG. 13C is a partial enlarged view of the dental device 1300 of FIG. 13A, showing a state in which the insertion portion 1340 of the dental bracket 1310 is engaged with the receiving member 1342 of the support member 1308. As shown in FIG. 13C, when the foregoing body 1340a is inserted into the opening 1342a of the receiving member 1342, an engagement is formed between the insertion portion 1340 and the receiving member 1342, such that the dental bracket 1310 is supported in a predetermined position. In certain embodiments, the engagement manner between the insertion portion 1340 and the receiving member 1342 may include an interference fit, a snap fit, magnetic attraction, or a combination thereof. For example, the size of the body 1340a may be slightly larger than the size of the opening 1342a, so as to form an interference fit; or the body 1340a may include a snap structure, and form a snap fit with a corresponding structure within the opening 1342a; or the body 1340a may include a magnetic material, and be mutually attracted with a magnetic material within the receiving member 1342.

By configuring the dental bracket 1310 and the support member 1308 as an insertion structure in which the insertion portion 1340 and the receiving member 1342 are mutually engaged, the dentist can pre-fabricate or select dental brackets 1310 having different specifications (for example, dental brackets of different sizes, different cutout configurations, or different connector configurations), and selectively assemble them to a respective receiving member 1342 of the support member 1308 according to the oral structure of the user. This configuration can improve the degree of modularity of the dental device 1300, and reduce the fabrication cost and time of a customized dental device. In addition, when any one dental bracket 1310 produces a defect or is damaged during the application process, that dental bracket 1310 can be replaced individually, without needing to replace the entire dental device 1300.

After the dental bracket 1310 is secured to a tooth, the dental bracket 1310 can be separated from the support member 1308 by cutting the at least one support stem 1340b of the insertion portion 1340. Specifically, since the body 1340a is engaged within the opening 1342a of the receiving member 1342, when the at least one support stem 1340b is cut, the body 1340a can be removed from the oral cavity together with the support member 1308, while the dental bracket 1310 remains secured to the tooth. The cutting of the at least one support stem 1340b may be performed by any suitable tool, for example, the cutter 824 shown in FIG. 8 or the drill 924 shown in FIGS. 9A to 9C. In certain embodiments, the dental device 1300 may further include a guide (not separately illustrated) similar to the guides 722, 822, 922 shown in FIGS. 7 to 9C, the guide being connected to the insertion portion 1340 (for example, connected to the at least one support stem 1340b), and disposed between the dental bracket 1310 and the support member 1308, so as to guide the precise cutting of the at least one support stem 1340b from the dental bracket 1310, thereby reducing or avoiding a residual portion of the support stem 1340b remaining on the dental bracket 1310 after cutting.

The structure and cooperation manner of the insertion portion 1340 and the receiving member 1342 may have a variety of variations. For example, in certain embodiments, the insertion portion 1340 may also extend from the support member 1308 towards the dental bracket 1310, while the receiving member 1342 is disposed on the dental bracket 1310, so as to form an opposite male-female structural configuration. In other embodiments, the insertion portion 1340 and the receiving member 1342 may further include an auxiliary connection structure therebetween (for example, a thread, a buckle, or an elastic latch), so as to enhance the stability of the engagement.

The features of the various embodiments of this disclosure can be integrated with each other. For example, the configuration of the segmented support member 1208 shown in FIG. 12 can be implemented in combination with the configuration of the insertion-type dental bracket 1310 shown in FIGS. 13A to 13C. That is, the support member 1308 may also include a plurality of segments arranged along an arch shape, and each of the segments includes a plurality of receiving members 1342, so as to accommodate the insertion portion 1340 of a respective dental bracket 1310. In addition, the configuration of the insertion-type dental bracket 1310 shown in FIGS. 13A to 13C can also be integrated into the integrally formed support members 108, 208, 308, 508, 708, 808, 908 shown in FIGS. 1 to 3 and 5 to 9; that is, the integrally formed support member may include a plurality of receiving members 1342, so as to accommodate the insertion portion 1340 of a respective dental bracket 1310. Through the foregoing combined embodiment, the multiple advantages of segmented convenient assembly, modular selection of dental brackets, and independent position adjustment can be simultaneously achieved.

This disclosure provides a mechanism that can directly bond an orthodontic appliance, the mechanism optionally including pre-threading a wire through a dental bracket and/or a dental device, and being capable of being applied quickly and efficiently. A dental device is provided that can be disposed on teeth, and pre-position dental brackets at positions adjacent to target teeth, such that the person applying the orthodontic appliance can quickly and one by one apply the dental brackets to the respective teeth. When all of the dental brackets are secured to the teeth, and are still connected to the support member via the extensions, the person applying the appliance can further adjust the individual position of each dental bracket on the teeth to a desired position. After the person applying the appliance confirms that each dental bracket has been adjusted to an appropriate position, the dental brackets can be separated from the extensions by bonding and/or cutting. This technique can substantially shorten the time for applying the orthodontic appliance and the wire to the teeth, and enable the person applying the appliance to dispose all of the dental brackets at approximate target positions on the teeth at one time, without needing to take them out one by one from an external tray or container and then apply them individually.

The foregoing outlines the features of several embodiments, enabling those skilled in the art to fully appreciate the aspects of the present disclosure. Those skilled in the art should recognize that the present disclosure provides a foundation for designing or modifying other processes and structures to achieve substantially the same functions and/or substantially the same results as those of the embodiments introduced herein. Furthermore, such equivalent arrangements do not deviate from the spirit and scope of the present disclosure, and various changes, substitutions, and alterations may be made without so departing.

What is claimed is:

1. A dental device, comprising:
a dental bracket, having a front side and a back side, configured to be secured to a respective tooth; and
a support member, connected to the dental bracket via an extension, wherein the extension supports the respective dental bracket in a predetermined position.

2. The dental device of claim 1, further comprising:
a guide, connected to the extension and disposed between the dental bracket and the support member, and configured to guide cutting of the dental bracket from the respective extension.

3. The dental device of claim 2, wherein the guide comprises:
a pair of appendages defining a pathway, the pathway being configured to guide cutting of the dental bracket from the respective extension.

4. The dental device of claim 2, wherein the guide comprises:
at least one opening defining a pathway, the pathway being configured to guide cutting of the dental bracket from a terminal end of the guide.

5. The dental device of claim 2, further comprising:
a cutter or a drill, configured to engage with the guide and to cut the dental bracket from the extension.

6. The dental device of claim 1, further comprising:
a wire pre-threaded through a connector of the dental bracket.

7. The dental device of claim 1, wherein:
the front side and the back side have a curved surface configured to align with a tooth, and the curved surface comprises a cutout to increase a surface area of the curved surface; and
the dental bracket comprises a connector, wherein the connector is connected with a wire.

8. The dental device of claim 1, wherein the support member, the dental bracket, and the extension are formed from a continuous mold.

9. The dental device of claim 1, wherein the dental bracket comprises a connector, the connector being connected with a wire.

10. The dental device of claim 1, wherein the support member comprises a block, the block being located on the respective tooth to guide the dental device.

11. The dental device of claim 1, wherein the support member is configured to rest on a palate of an oral cavity of a user, so as to cause the dental bracket to extend towards the respective tooth.

12. The dental device of claim 1, further comprising:
a clear aligner fitted over the respective tooth, wherein the dental bracket is embedded in the clear aligner.

13. The dental device of claim 12, wherein the dental bracket is disposed on a lingual side of the respective tooth.

14. The dental device of claim 1, wherein the dental bracket is detachable from the support member of the dental device, wherein the support member is configured to guide application of the dental bracket to the respective tooth.

15. A dental bracket, corresponding to the dental device of claim 1, wherein the dental bracket comprises a connector and a wire, wherein the connector is connected with the wire.

16. The dental bracket of claim 15, wherein the connector comprises:
an opening penetrating from one surface of the dental bracket to another surface, so as to allow the wire to pass through the dental bracket.

17. The dental bracket of claim 16, wherein the connector comprises:
a stanchion configured to secure the wire when a band is applied to the stanchion; or
a channel penetrating through the dental bracket.

18. A dental device, comprising:
a plurality of dental brackets, each configured to be secured to a respective tooth; and
a support member, connected to the plurality of dental brackets via a plurality of extensions, wherein the support member comprises a plurality of segments arranged along an arch shape, and each of the segments supports at least one of the plurality of dental brackets in a predetermined position via at least one of the plurality of extensions.

19. The dental device of claim 18, wherein the plurality of segments comprise a left front section, a right front section, a left rear section, and a right rear section, respectively corresponding to respective regions of an oral cavity of a user.

20. The dental device of claim 18, wherein adjacent segments among the plurality of segments are separated from each other.

21. The dental device of claim 18, wherein adjacent segments among the plurality of segments are connected to each other via a latch structure, and the latch structure is configured to be detachable.

22. The dental device of claim 21, wherein the latch structure comprises:
a tenon disposed at an end portion of one of two adjacent segments among the plurality of segments; and
a mortise disposed at an end portion of the other of the two segments, wherein a shape of the mortise corresponds to the tenon.

23. The dental device of claim 18, wherein each of the segments is integrally formed from a continuous material.

24. The dental device of claim 18, further comprising:
a guide, connected to a respective extension among the plurality of extensions and disposed between a respective dental bracket among the plurality of dental brackets and the support member, and configured to guide cutting of the respective dental bracket from the respective extension.

25. A dental device, comprising:
a support member, comprising a plurality of receiving members; and
a plurality of dental brackets, each configured to be secured to a respective tooth, and each of the dental brackets comprising an insertion portion, wherein the insertion portion of each of the dental brackets is engaged with a respective receiving member among the plurality of receiving members, such that each of the dental brackets is supported in a predetermined position through the engagement of the respective receiving member with the insertion portion.

26. The dental device of claim 25, wherein the insertion portion comprises a body and at least one support stem extending from the body, the at least one support stem being connected to a respective dental bracket among the plurality of dental brackets.

27. The dental device of claim 26, wherein the body has a shape of a block, a column, a rectangle, a polygon, or any combination thereof.

28. The dental device of claim 26, wherein the at least one support stem is configured to be cut, so as to separate a respective dental bracket among the plurality of dental brackets from the support member, and the body remains engaged with a respective receiving member among the plurality of receiving members after the at least one support stem is cut.

29. The dental device of claim 25, wherein each of the receiving members comprises an opening for accommodating a respective insertion portion.

30. The dental device of claim 25, wherein an engagement manner between the insertion portion of each of the dental brackets and a respective receiving member among the plurality of receiving members comprises an interference fit, a snap fit, magnetic attraction, or a combination thereof.

31. The dental device of claim 25, wherein a position of each of the dental brackets on the support member is independently adjustable.

32. The dental device of claim 25, wherein the support member comprises a plurality of segments arranged along an arch shape, and each of the segments comprises at least one of the plurality of receiving members.

33. The dental device of claim 25, wherein the support member is integrally formed from a continuous material.

34. The dental device of claim 25, further comprising:
a wire pre-threaded through a connector of each of the dental brackets.

35. The dental device of claim 25, further comprising:
a guide, connected to the insertion portion and disposed between a respective dental bracket among the plurality of dental brackets and the support member, and configured to guide cutting of the insertion portion from the respective dental bracket.

36. A dental bracket, comprising:
a back side; and
a front side configured to be secured to a respective tooth, the front side comprising a recess and a weakened portion disposed in the recess, wherein the weakened portion connects the dental bracket with an extension and is configured to be broken so as to separate the extension from the dental bracket.

37. The dental bracket of claim 36, wherein the recess is one of a plurality of recesses on the front side, the weakened portion is one of a plurality of weakened portions respectively disposed in the plurality of recesses, and each of the weakened portions connects the dental bracket with a respective extension.

38. The dental bracket of claim 36, wherein the weakened portion comprises an anchor point, the anchor point being a protruding structure or a spike-shaped structure.

39. The dental bracket of claim 36, wherein the weakened portion fills the recess.

40. The dental bracket of claim 36, wherein the front side and the back side have a curved surface configured to align with a tooth.

41. The dental bracket of claim 36, wherein the weakened portion is semi-hollow such that a density of the weakened portion differs from a density of a portion of the dental bracket surrounding the recess.

42. The dental bracket of claim 36, wherein the weakened portion is integrally printed with the dental bracket and the extension through a 3D printing process, or is a coating layer formed at a junction between the dental bracket and the extension through a chemical coating process, the coating layer constituting the weakened portion connecting the dental bracket and the extension.
